(19) United States
(12) Patent Application Publication
(10) Pub. No.: US 2007/0125265 A1
(43) Pub. Date: Jun. 7, 2007

(54) Foundry bond pre-mix, apparatus and methods

(75) Inventor: Duane A. McVane, Ashwaubenon, WI (US)

Correspondence Address: WILHELM LAW SERVICE, S.C., 100 W LAWRENCE ST, THIRD FLOOR, APPLETON, WI, 54911, US

(73) Assignee: New Ideas Engineering, LLC, Kaukauna, WI (US)

(21) Appl. No.: 11/607,652

(22) Filed: Dec. 1, 2006

Related U.S. Application Data
(60) Provisional application No. 60/741,847, filed on Dec. 1, 2005.

(51) Int. Cl. C04B 35/66; B01F 15/02; B22C 5/04

(52) U.S. Cl. 106/38.27; 106/38.28; 366/8; 366/136; 366/144; 366/152.1; 366/153.1

(57) ABSTRACT

Apparatus and methods for preparing foundry sand mixes, using a pre-mix tank to pre-mix water and particulate bond material to make a water/bond slurry, then delivering the slurry into the foundry sand recovery stream. The slurry is mixed with return sand, and then discharged for use in making foundry molds. Delivery of the slurry to the sand stream can take the place of all particulate addition of bond to the sand stream. The slurry optionally is worked through a recycle stream, an accumulator tank, or both. A invention contemplates mixing, recycling, holding, and delivering the slurry to the sand system. The slurry can be delivered to multiple sand system entry loci at the mixer/mullor and/or the sand cooler. Slurry can be made up in batches or on a continuous basis. Slurry delivery can be batch, or continuous, with optional variability in rate of slurry delivery.

### BACKGROUND

In foundries, metal is poured into molds which are fabricated from special mixes of sand and special-purpose bond/adhesive compositions. This invention addresses apparatus and methods for making, using, and recycling the sand mix. The invention specifically addresses use of particulate bond materials which remain in particulate form when mixed with water.

In making the sand mix, sand is mixed with water, and with the bond material. The bond material is a finely-powdered mixture of e.g. bentonite clay, coal, and a combination of compatibilizers, stabilizers, wetting agents, and the like.

In conventional sand preparation, the sand mix is generally made up in a mullor. In general, a mullor is a special purpose mixing tank. Sand and bond material are metered into the mullor at specified ratios or rates. Water is added to the tank in defined quantity. A typical charge to the mullor is comprised primarily of return sand, with make-up quantities of fresh bond material and fresh sand, in combination with a sufficient quantity of water to bring the resultant water content of the mix to the desired level.

A mix motor or the like rotates mixing paddles and/or wheels inside the mullor to mix the respective components placed therein. The mixing of sand in the mullor can be either a batch process or a continuous stream process. The exiting sand is preferably tested against a standard, and adjustments to the dry or wet ingredients currently in the mullor are made in response to results of those tests of completed product which have recently exited the mullor. Thus mix adjustments for a current mixture of material in the mullor are based at least in part on the test results from one or more sand mix compositions which have already left the mullor.

Typical bond material is a finely powdered particulate material, so fine as to easily become airborne as dust in a gaseous environment so as to become entrained in the air inside the mullor. Such particulate bond material is in general smaller than 200 mesh, and is typically added to the mullor in dry form, and thus is susceptible to becoming air borne until such time as the respective particles become wetted with the water. The wetting process is part of the function of the mulling operation. In principle, it is desirable that the mullor uniformly disperse the fresh sand and fresh bond material, and that substantially all bond particles and all sand particles become wetted by the time they leave the mullor.

In general, the sand particles tend to be relatively hydrophilic while the bond material particles tend to be relatively hydrophobic. Thus, the water tends to be more attracted to the relatively larger sand particles than to the relatively smaller bond material particles whereby the general tendency for wetting sand particles with a given batch of water is greater than the relative tendency for wetting bond particles with the respective batch of water. Namely, absent an excess of water, the water is selective in tending to wet sand surfaces more readily than bond material surfaces, thereby running the risk that a significant fraction of the bond particles may not be wetted. Accordingly, one of the objects of this invention is to increase the fraction of the fresh bond particles which are effectively wetted by the water.

In conventional processes for making the sand mix, a fresh addition of bond material is fed into the mullor as a stream of dry particles, e.g. transported pneumatically or dropped by gravity into the mullor receptacle. As the dry particulate bond material enters the mullor receptacle in the conventional manner, a first fraction of the bond material can and does become entrained in the air through which the bond material passes as the bond material drops to either the bottom of the tank or onto a mass of sand, water, and/or other bond material already in the tank. A further fraction of the bond material can become entrained in one or more dust collection inlets which are positioned adjacent the mullor to control air-borne dust. In addition, to the extent bond material lands on underlying dry material already in the mullor, e.g. relatively dry return sand or previously added and still-dry bond material, the dropping dry bond material particles which land on the surface of such underlying material are free to become air-borne upon sufficient agitation or other disturbance, whether solid, liquid, or gaseous agitation, and/or to be simply lifted off the dry surface by incident currents of the ambient air. So long as such small particles are not wetted, the particles readily go air-borne upon even mild agitation.

Accordingly, one of the primary sources of dust in foundry operations is dry, or relatively dry, particulate bond material which is in the sand system or which is in the process of being fed into the sand system. A first mechanism for such dust to become air-borne is bond material which becomes dispersed in the air inside the mullor as the bond material is being added to the mullor, and as the bond material is in general being mixed with the sand and water. Since bond material, sand, and water are repeatedly or constantly being added to the mullor, and discharged from the mullor, there is an ongoing, optionally intermittent, flow of air into the mullor, and out of the mullor. If no controls are placed on flow of such air, much of the air which exits the mullor will pass to ambient, and will carry with it substantial quantities of air-borne particulate bond material pollution.

Accordingly, it is well known to provide dust collection apparatus as part of a sand system, for capturing particulate material which becomes or remains entrained in the air in the mullor and in other parts of the sand system. Typical foundry sand systems generate waste particulate bond material, much of such particulate bond material being collected in the dust collection system, amounting to about 25 percent to about 50 percent by weight of the particulate make-up bond material which is being fed to the sand systems. Restated, only about 50 percent by weight to about 75 percent by weight of the bond material which is fed into a conventional foundry sand system manages to become integrated into the sand mix, as opposed to being carried off by air currents into the dust collection system.

In addition to providing for addition of make-up quantities of bond material to the sand system, provisions are also conventionally made for addition of make-up quantities of sand. Sand can be lost e.g. as dust. However, the usefulness of the sand is degraded with use. Accordingly, there is a need to routinely and regularly remove used sand from the sand system and to replace that used sand with fresh sand, or regenerated sand. As used herein, “regenerated sand” refers to sand which has been removed from the sand system use cycle, and which has been regenerated using known processes by e.g. washing, removal of non-sand materials, sizing, and the like.

It is common for the sand system to be operated on a pro-active replacement basis, wherein sand is routinely removed from the system, and replaced by adding sand at e.g. the sand mixing stage of the sand system. While sand can be selected for removal according to a number of factors, it is common to pass the sand through sizing screens at the work stations where the sand molds are broken away from the cast metal parts, and to remove from the sand system any chunks of sand which do not pass through the sizing screens. In addition, it is common to deposit the return sand in one or more surge tanks, and to remove from the sand system any sand which accumulates in the surge tanks above a pre-set volume level.

Such accumulation can occur, for example, where the sand mix prepared at the sand mixing station contains a first pre-determined fraction of return sand and a second pre-determined fraction of fresh make-up sand. Where the quantity of the fresh make-up sand is greater than the quantity of sand lost in use of the sand system, the overall quantity of sand in the sand system potentially increases by the difference. It is such difference which represents the quantity of sand which is removed from the surge tanks, thereby to balance the quantity of sand leaving the sand system with the quantity of sand entering the sand system at the sand mix process.

In general, material collected in a dust collection system which is connected to a sand system cannot be economically recycled into the sand system, and is thus sent to land fill as waste. Such waste adds to the cost of the process, in that (I) bond material purchased for the purpose of making sand mix is sent to land fill either prematurely before utility of such bond material is exhausted, or without ever being used at all as part of the sand mix; and in that (ii) the cost of the land filling operation is greater than a minimum threshold amount theoretically required by foundry operations.

In addition, in conventional processes, bond material which is not wetted, and wherein bonding properties are accordingly not activated by the water, but which is nonetheless captured as trapped particles in the sand mix, is inactive and thus does not act in a bonding capacity in the sand mix, and thus can become inadvertently separated from the sand mix during mold casting and cooling. Such separation of bond material particles from the sand mix can leave voids and cavities in the mold, which enable development of inconsistencies in the metal parts which are molded using such molds. Such inconsistencies can affect the qualities, including strength properties, of sand molds made with such sand mix, and can correspondingly affect the ranges of various properties of metal parts in a population of such metal parts cast in molds made with such sand mix.

Known dust collection systems are capable of capturing substantial fractions of the dust so generated. However, as with all known dust collection systems, the cost of collecting the dust increases greatly as one increases the required fraction of the dust which is to be collected. Unless extreme measures are taken to collect absolutely all dust, and such measures are usually prohibitively expensive, some fraction of the dust always eludes collection and thus makes an incremental contribution to ongoing particulate pollution of the ambient air and thereby has a deleterious affect on air quality in the surrounding community.

Since air pollution standards generally address absolute quantities of pollutants emitted, not fractions of the quantity of pollutant generated by the process of interest, when the quantity of particulates generated increases, the amount of collection effort required increases by a like amount. Conversely, where the quantity of particulates generated is reduced, the amount of collection effort required can decrease by a like amount. Thus, there is an ongoing social and political incentive to reduce the quantity of particulate material which is released into ambient air. There is a corresponding financial incentive for the operator of the foundry to reduce the quantity of particulate material which is produced, and which must thus be controlled and/or captured as a result of the sand system and process.

In foundry systems of interest in this invention, the primary sources of the dust of interest are the bond material which is not wetted or otherwise captured by the water or the wetted sand, and bond material which is released at or after mold breakage.

Bond material particles which become wetted by water correspondingly have taken on increased weight by the addition of the water and are thus larger and more dense, whereby an increased level of energy is required to make such particles air borne. In addition, such wetted particles develop adhesive properties as a result of such wetting. These adhesive properties serve to inhibit the particles becoming or remaining air borne when such particles are in contact with each other or with e.g. respective sand particles.

The inventor herein contemplates that the primary reason bond material is lost in the sand mixing process is because the fine particles of bond material never become sufficiently wetted with water in the process of being mixed with the sand and water, which mixing is commonly effected in the mullor. The inventor contemplates that such particles do not pick up sufficient added weight of water and/or are not actively bonded to the sand to effectively inhibit the particles becoming air-borne.

In any event, that bond material which is not bonded to the sand, and which is not otherwise captured as part of the mass which defines the sand mixture, can readily become air-borne because the particles are sufficiently light in weight to be moved by typical air movements in the mullor, or picked up by the dust collection system. Such air-borne particles must be removed from the air stream which passes through the processing equipment, whether at sand mixing, in the sand return system, or elsewhere in the sand system, and must be captured by dust recovery apparatus and dust recovery process steps, lest such particulate matter escape into the ambient atmosphere and thereby become air-borne particulate air pollution. The dust collection sub-systems which are attached to foundry sand systems are thus designed, configured, and operated, to collect such particles in quantities which are typically generated in foundry operations.

It is desirable to reduce the quantity of bond material which must be collected by dust collection apparatus in a sand system operation.

It is further desirable to provide apparatus and methods for making a bond slurry including providing a level sensor in the pre-mix tank, which senses the level of slurry in the tank.

Yet another desire is to provide apparatus and methods for wetting fresh bond material and making a slurry of such bond material and water, wherein the bond feed conveyor to the pre-mix/slurry tank has a variable speed drive.

It is still further desirable to provide apparatus and methods for making a bond slurry wherein the slurry discharge from the pre-mix tank has a variable speed drive.

Another desire is to provide apparatus and methods for making a bond slurry, including a recycle line back to the pre-mix tank.

Still another desire is to provide apparatus and methods which include use of an accumulator tank, with optional by-pass line, to hold pre-mixed slurry, ready to be fed to the sand system, e.g. at a mullor or sand cooler.

A further desire is to provide novel foundry sand mix compositions.

It is also desirable to provide apparatus and methods for making foundry sand mixes which can feed into either a batch fed sand mixing process or a continuous sand preparation process.

It is yet further desirable to provide apparatus and methods for pre-mixing water and bond material and thence feeding into a single mullor or other sand preparation or conditioning apparatus, or feeding selectively from the bond mix tank into a plurality of mullors or other sand preparation or conditioning apparatus.

It is further desirable to increase activation of the bond material by recycling, optionally continuously recycling, the bond mixture through the mix tank and/or through an accumulator tank.

### SUMMARY

This invention contemplates apparatus and methods for preparing foundry sand mixes, using a pre-mix tank to pre-mix water and particulate bond material to make a water/bond slurry, then delivering the slurry into the return foundry sand stream. The slurry is mixed with return sand, and then discharged for use in making foundry molds. Delivery of the slurry to the sand stream can take the place of all, or a portion, of the particulate addition of bond to the sand stream. The slurry optionally is worked through a recycle stream, an accumulator tank, or both. The invention contemplates mixing the slurry, recycling the slurry, temporarily holding the slurry, and delivering the slurry to the sand system. The slurry can be delivered to multiple sand system entry loci at the mixer/mullor and/or the sand cooler. Slurry can be made up in batches or on a continuous basis. Slurry delivery can be batch, or continuous, with optional variability in rate of slurry delivery.

In a first set of embodiments, the invention comprehends apparatus for preparing bond for delivery to a foundry sand system in a foundry. The apparatus comprises a pre-mix system. The pre-mix system comprises a pre-mix tank adapted and configured to receive thereinto particulate bond material and a liquid carrier therefore, to prepare a slurry of such particulate bond material and such liquid carrier, and to discharge such slurry from the pre-mix tank; a bond conveyor adapted to convey particulate bond material to a first feed port in the pre-mix tank; and a prime mover driving the bond conveyor. The prime mover comprises a variable speed drive adapted to adjust feed rate of the bond material in real time to the pre-mix tank. The prime mover can thus receive sequential real time drive speed commands from a controller controlling activities of the pre-mix system, and adjust feed rate of the bond material to the pre-mix tank to correspond with the speeds so commanded.

In some embodiments, the apparatus includes a water feed line feeding into the slurry feed line upstream of the third feed port.

In some embodiments, the apparatus includes water spray apparatus associated with a second feed port in the pre-mix tank, the water spray apparatus being designed, configured, and positioned to apply a disperse spray of water onto a stream of bond material particles traversing an open space in the pre-mix tank.

In some embodiments, the apparatus includes a pre-mix controller which controls quantities and timing of addition of carrier liquid, such as water, and bond material to the pre-mix tank.

In some embodiments, the apparatus includes a water line feeding the water spray apparatus in association with the second feed port in the pre-mix tank, and further comprises a water meter in the water feed line which meters desired quantities of water to the water spray apparatus.

In some embodiments, the pre-mix tank further comprises driven mixing apparatus adapted to mix the particulate bond material and the liquid carrier to thus form the slurry.

In some embodiments, the slurry discharge pump has a variable speed drive thus to vary the rate of discharging the slurry from the pre-mix tank to at least one of the recycle line and the sand system.

In some embodiments, the pre-mix tank is devoid of active powered mix apparatus inside the pre-mix tank.

In a second family of embodiments, the invention contemplates apparatus for preparing bond for delivery to a foundry sand system in a foundry. The apparatus comprises a pre-mix tank adapted and configured to receive thereinto particulate bond material and a liquid carrier therefore, to prepare a slurry of such particulate bond material and such liquid carrier, and to discharge such slurry from the pre-mix tank; a discharge line connected to the pre-mix tank at a discharge port, and adapted to receive such slurry from the pre-mix tank and to feed such slurry to a sand system in such foundry, further comprising a slurry discharge pump in the slurry discharge line; and a recycle line connected to the discharge line downstream of the slurry pump and connected to the pre-mix tank so as to convey a recycle stream of such slurry back to the pre-mix tank.

In some embodiments, the apparatus further comprises a mixer/mullor adapted to receive thereinto sand, liquid carrier, and bond material, as part of the foundry sand system, and to produce therefrom a foundry sand mix which can be bonded together so as to be operable for making foundry sand molds, the slurry discharge line being connected to the mixer, and feeding the slurry to the mixer at a third feed port in the mixer.

In some embodiments the pre-mix tank comprises a bottom wall, and an upstanding outer wall extending upwardly from the bottom wall to a top of the pre-mix tank, and defining an outer perimeter of the pre-mix tank, and an inner wall, disposed inwardly of the outer wall, and extending upwardly from the bottom wall to a locus below the top of the tank, a first cavity thus being defined between the inner wall and the outer wall, and a second slurry-holding cavity being defined inwardly of the inner wall, the inner wall preventing liquid from traversing laterally outwardly from the second cavity to the first cavity.

In some embodiments the apparatus further comprises a prime mover driving the bond conveyor, the prime mover comprising a variable speed drive adapted to adjust feed rate of the bond material in real time to the pre-mix tank.

In a third family of embodiments, the invention comprehends apparatus for preparing a foundry sand mix for use in a sand system in a foundry. The apparatus comprises a pre-mix tank adapted and configured to receive thereinto particulate bond material and a liquid carrier therefore, to prepare a slurry of such particulate bond material and such liquid carrier, and to discharge such slurry from the pre-mix tank; a foundry sand system adapted to receive thereinto sand and the slurry, and to produce therefrom a foundry sand mix which can be bonded together by the particulate bond material thereby to make foundry sand molds; a slurry discharge line connecting the discharge port to the foundry sand system, and adapted to receive the slurry from the pre-mix tank and to feed the slurry to the foundry sand system; a slurry discharge pump in the slurry discharge line; and a variable speed drive driving the slurry discharge pump, and adapted to adjust feed rate of the slurry in real time to the foundry sand system, whereby the variable speed drive can receive sequential real time drive speed commands from a control system, and adjust feed rate of the slurry to the foundry sand system to correspond with the drive speeds so commanded.

In some embodiments, the sand system comprises a sand cooler, the slurry discharge line being connected to the sand cooler, and feeding the slurry to the sand cooler.

In some embodiments, the apparatus includes a bond material hopper, and a bond conveyor which conveys particulate bond material from the hopper to a feed port in the pre-mix tank.

In a fourth family of embodiments, the invention comprises apparatus for use in preparing sand mixes in a sand system in a foundry. The apparatus comprises a pre-mix tank adapted and configured to receive thereinto particulate bond material and a liquid carrier therefore, and to make and discharge a slurry of such bond material and such liquid carrier from the pre-mix tank; an accumulator tank adapted and configured to receive such slurry from the pre-mix tank, and to hold such slurry in condition ready for use in such foundry sand system; a first slurry discharge line connecting the pre-mix tank to the accumulator tank, the first slurry discharge line being adapted to receive such slurry from the pre-mix tank and to feed such slurry to the accumulator tank; and a second slurry discharge line connecting the accumulator tank to the foundry sand system and adapted to receive slurry from the accumulator tank and to feed the slurry to the foundry sand system.

In some embodiments, the apparatus further comprises a pre-mix tank discharge pump in the first slurry discharge line, and a recycle line connected to the first slurry discharge line downstream of the pre-mix tank discharge pump and connected to the pre-mix tank so as to convey a recycle stream back to the pre-mix tank.

In some embodiments, the apparatus further comprises an accumulator tank discharge pump in the second slurry discharge line, and a recycle line connected to the second slurry discharge line downstream of the accumulator tank discharge pump and connected to the accumulator tank so as to convey a recycle stream back to the accumulator tank.

In some embodiments, the foundry sand system comprises a mixer, adapted to receive thereinto sand and the slurry, and to produce therefrom a foundry sand mix which can be bonded together so as to be operable for making foundry sand molds, the second slurry discharge line being connected to the mixer, and feeding the slurry to the mixer.

In some embodiments, the sand system comprises a sand cooler, the first slurry discharge line being connected to the sand cooler, through a by-pass line, and feeding the slurry to the sand cooler.

In a fifth family of embodiments, the invention comprehends apparatus for preparing foundry sand mixes, comprising a pre-mix tank; a first sand system entry locus comprising at least one of a first sand mixer and a first sand cooler; a second sand system entry locus comprising at least one of a second sand mixer and second sand cooler; and discharge lines connecting the pre-mix tank to the first and second sand system entry loci, in parallel, thereby to deliver such slurry from the pre-mix tank to the respective sand system entry loci.

In some embodiments, the apparatus further comprises a recycle line in at least one of the discharge lines and connected to the pre-mix tank so as to convey a recycle stream of the slurry back to the pre-mix tank.

In some embodiments, the apparatus further comprises a level sensor, optionally a radar sensor, in the accumulator tank, adapted to sense a top surface of the slurry in the accumulator tank.

In some embodiments, the apparatus comprises a single discharge pump feeding the slurry through the discharge lines, the discharge lines extending along first and second different paths downstream of the discharge pump, further comprising variable flow rate valves in the discharge lines, controlling rates of flow of such slurry individually along the first and second different paths.

In some embodiments, the discharge lines extend, from a junction of the discharge lines, along first and second different paths downstream of the junction, further comprising a discharge pump in each discharge line downstream of the junction.

In some embodiments, the apparatus further comprises a by-pass line by-passing the accumulator tank such that slurry can be fed to at least one of the first and second entry loci of the sand system without traversing the accumulator tank.

In some embodiments, the pre-mix tank comprises a first pre-mix tank, further comprising a second pre-mix tank adapted and configured to receive thereinto particulate bond material and a liquid carrier therefore, to prepare a slurry of such particulate bond material and such liquid carrier, and to discharge such slurry from the second pre-mix tank, the second pre-mix tank being connected to the discharge lines, further comprising one or more pumps, and suitable valves, such that slurry can be delivered from either of the pre-mix tanks to any of the first and second sand system entry loci.

In a sixth family of embodiments, the invention comprehends apparatus for preparing bond for delivery to a foundry sand system in a foundry, the apparatus comprising a pre-mix tank; a discharge line connected to the pre-mix tank at a discharge port, and adapted to receive the slurry from the pre-mix tank and to feed the slurry to a sand system in the foundry, further comprising a slurry discharge pump in the slurry discharge line; and a level sensor, optionally a radar sensor, adapted to sense a top surface of the slurry in the pre-mix tank.

In another family of embodiments, the invention comprehends, in combination, a foundry sand system and a bond delivery system, comprising at least one pre-mix tank adapted and configured to receive thereinto particulate bond material and a liquid carrier therefore, to prepare a slurry of such particulate bond material and such liquid carrier, and to discharge such slurry from the at least one pre-mix tank; at least first and second sand system entry loci which receive sand from a sand recovery system, each such sand system entry locus comprising a sand mixer; one or more discharge lines connecting the at least one pre-mix tank to the first and second sand system entry loci such that slurry discharged from the at least one pre-mix tank is delivered to the at least first and second sand system entry loci; sand belts downstream of the at least first and second sand mixers and receiving sand mix from the at least first and second sand mixers; a distribution belt receiving sand mix from the sand belts; and a plurality of mold lines receiving sand mix from the distribution belt.

In some embodiments, at least one of the sand system entry loci comprises a sand cooler.

In still another family of embodiments, the invention comprehends a novel foundry sand mix, comprising sand, particulate bond material, and water. The foundry sand mix includes a return sand fraction having a first set of material specifications and a fresh sand fraction having a second set of material specifications. The return sand fraction comprises return sand particles and return bond material particles. The fresh sand fraction comprises fresh sand particles and fresh bond material particles. The combination of the return sand fraction and the fresh sand fraction, when mixed together in a process at a given ratio of fresh sand to return sand, in an environment wherein the fresh sand particles and the fresh bond particles, in combination, comprise no more than 5 percent by weight water when introduced to the mix process, and wherein the fraction of fresh bond material to fresh sand particles is a base quantity by weight, and wherein the fresh bond particles are added directly to a sand composition containing no more than 3 percent by weight water, having potential to develop a first level of green sand strength when used to make a sand mold for use in foundry operations, The foundry sand mix of the invention, using a return sand fraction having substantially the first set of material specifications and a fresh sand fraction having substantially the second set of material specifications, having a capacity, when mixed together at the given ratio, to develop the first level of green sand strength with no more than 85 percent by weight, optionally no more than 80 percent by weight, optionally no more than 75 percent by weight, optionally no more than 70 percent by weight, of the base quantity of fresh bond material particles in the fresh sand fraction.

In another family of embodiments, the invention comprehends a method of preparing bond material for addition to a foundry sand system. The method comprises pre-mixing the bond material in a pre-mix tank, with enough water to make a pumpable slurry of the bond material and water; and discharging the slurry from the pre-mix tank and pumping the discharged slurry through a pump thereby further working the slurry, and returning at least a recycle portion of the slurry to the pre-mix tank through a recycle line.

In some embodiments, the method further comprises initially recycling all of the discharged slurry to the pre-mix tank through the recycle line thereby to work the slurry without necessarily transferring any of the slurry to the sand system.

In some embodiments, the method further comprises subsequently enabling flow of a first portion of the discharged slurry to the sand system while recycling a second portion of the discharged slurry back to the pre-mix tank.

In yet another family of embodiments, the invention comprehends a method of preparing a foundry sand mix, comprising pre-mixing fresh bond material in a pre-mix tank, with enough water to make a pumpable slurry of the bond material and water; delivering the slurry to a first sand system process stream processing recovered sand, and comprising at least one of a first mixer and a first sand cooler; delivering the slurry to a second sand system process stream processing recovered sand, and comprising at least one of a second mixer and a second sand cooler; and at each of the first and second sand system process streams, adding sufficient water to restore water content of the sand to a desired amount for discharge from the respective mixer.

In some embodiments, the method further comprises delivering the slurry from the pre-mix tank to an accumulator tank, and delivering the slurry from the accumulator tank to the first and second process streams.

In some embodiments, the method further comprises recycling at least a portion of the slurry from a discharge line exiting the pre-mix tank, through a pump, thereby further working the slurry, and returning the recycle stream to the pre-mix tank.

In some embodiments, the method further comprises continuing to feed bond material and water to the pre-mix tank while discharging slurry from a discharge port in the pre-mix tank.

In some embodiments, the method further comprises a control system controlling at least the return sand portion of the foundry sand system, and maintaining an ongoing discharge of slurry from the pre-mix tank, and feeding slurry to the sand system process streams, from the pre-mix tank discharge stream, as periodically requested by the control system.

In another family of embodiments, the method comprehends a method of preparing a foundry sand mix, using return sand, fresh sand, fresh bond, and water, for use in a foundry sand system. The method comprises determining an amount of fresh bond material, fresh sand, and water which needs to be added to a stream of return sand; pre-mixing fresh bond material in the needed amount in a pre-mix tank, with enough water to make a pumpable slurry of the bond material and water; delivering a first portion of the slurry, including bond material and water, to the return sand stream in a sand mixer; and delivering a second remainder portion of the slurry, including bond material and water, to the return sand stream in a sand cooler which feeds the sand mixer, thereby delivering the entirety of the determined amount of bond material to the return sand stream in slurry form; delivering the determined amount of fresh sand to the return sand stream; and delivering any balance of the determined amount of fresh water to the return sand stream.

In some embodiments, the method further comprises delivering the slurry from the pre-mix tank to an accumulator tank, and delivering the slurry from the accumulator tank to the mixer and the sand cooler.

In a further family of embodiments, the invention comprehends a method of preparing a foundry sand mix, using return sand, a determined amount of fresh sand, a determined amount of fresh bond, and a determined amount of water, for use in a foundry sand system. The method comprises pre-mixing fresh bond material in a pre-mix tank, with enough water to make a pumpable slurry of the bond material and water; and discharging the slurry from the pre-mix tank into a first discharge line capable of delivering the slurry to an accumulator tank adapted and configured to receive such slurry from said pre-mix tank, to hold such slurry in the accumulator tank in condition ready for use in such foundry sand system, and subsequently to discharge the slurry from the accumulator tank into a second discharge line, and thence to the foundry sand system, thereby adding at least a portion of the determined amounts of bond and water to the sand system.

In some embodiments, the method further comprises recycling at least a portion of the slurry from the second discharge line, back into the accumulator tank.

In some embodiments, the method further comprises conveying the slurry from the discharge line into a by-pass line effective to by-pass the accumulator tank in delivering the slurry to the sand system.

In some embodiments the method further comprises monitoring the level of slurry in the pre-mix tank using a surface level sensor, optionally a radar sensor, inside the pre-mix tank and/or inside the accumulator tank.

In yet another family of embodiments, the invention comprehends a method of satisfying a changed demand for fresh bond addition in a foundry sand system which typically operates on an ongoing basis with a generally stable baseline composition demand for fresh bond. The method comprises using a control system to establish the baseline composition demand for draws of fresh bond to the foundry sand system; making a slurry in a pre-mix tank, capable of satisfying the baseline demand for fresh bond; transferring the slurry capable of satisfying the baseline demand for fresh bond to an accumulator tank and holding, in the accumulator tank, a quantity of the slurry capable of satisfying multiple routine draws of slurry to the sand system, as requested by the control system; discharging multiple draws of the slurry, in requested quantities, to the foundry sand system; and upon perceiving a need for a slurry composition which cannot be satisfied from the slurry in the accumulator tank, making up a supply of slurry in the pre-mix tank, corresponding to the requested slurry composition, and delivering the requested composition and amount of slurry to the foundry sand system through a by-pass line which by-passes the accumulator tank.

In some embodiments, the method further comprises monitoring subsequent needs for slurry, and continuing to satisfy slurry requests through the by-pass line until a need can be satisfied with the base-line composition, and then satisfying the baseline composition need from the slurry which is being held in the accumulator tank.

In some embodiments, the method further comprises at least periodically discharging slurry from the accumulator tank, passing such slurry through a pump, thereby continuing to work the slurry, and returning the slurry to the accumulator tank through a recycle line.

In still another family of embodiments, the invention comprehends a method of preparing a foundry sand mix, using return sand, a determined amount of fresh sand, a determined amount of fresh bond, and a determined amount of water, for use in a foundry sand system. The method comprises pre-mixing fresh particulate bond material in a pre-mix tank, with enough water to make a pumpable slurry of the bond material and water; discharging the slurry from the pre-mix tank into a discharge line and passing the slurry through a pump capable of delivering the slurry to the foundry sand system through the discharge line, and through a valve capable of closing off instructed portions of flow of the slurry; receiving a delivery command commanding adjustment of rate of delivery of the slurry to the foundry sand system; and adjusting at least one of (I) a setting on the valve and (ii) output speed of the pump, thereby to adjust rate of flow of slurry to the sand system to correspond with the commanded rate adjustment.

### BRIEF DESCRIPTION OF THE DRAWINGS

FIG. 1 shows in block diagram form certain basic elements of a typical foundry sand system which incorporates the invention.

FIG. 2 shows a representative side elevation view of a sand mixing system, including pre-mix tank and mullor, which can be used in the invention.

FIG. 3 shows a representative side elevation view of a second sand mixing system, including pre-mix tank and mullor, which can be used in the invention.

FIG. 4 shows a representative side elevation view of a third sand mixing system, including pre-mix tank, mullor, and recycle line to the pre-mix tank.

FIG. 5 shows a representative side elevation view of a fourth sand mixing system, including a modified pre-mix tank, a mullor, and a recycle line.

FIG. 6 shows a representative side elevation view of a fifth sand mixing system, including pre-mix tank, mullor, accumulator tank, and respective recycle lines.

FIG. 7 shows an exemplary representative block diagram illustrating certain basic elements of a typical foundry system, using a single pre-mix tank to feed multiple mullors and/or sand coolers.

FIG. 8 shows an exemplary representative block diagram illustrating certain basic elements of a typical foundry system, using multiple pre-mix tanks to feed multiple mullors and/or sand coolers.

FIG. 9 shows an exemplary representative plant layout, in plan view, illustrating the basic elements of a typical foundry system using one, and optionally multiple, pre-mix tanks to feed a sand belt, optionally multiple sand belts, which feed multiple mullors and/or sand coolers.

FIG. 10 shows an exemplary flow diagram illustrating feeding slurry to both a mullor and a sand cooler.

The invention is not limited in its application to the details of construction or the arrangement of the components set forth in the following description or illustrated in the drawings. The invention is capable of other embodiments or of being practiced or carried out in other various ways. Also, it is to be understood that the terminology and phraseology employed herein is for purpose of description and illustration and should not be regarded as limiting. Like reference numerals are used to indicate like components.

### DESCRIPTION OF THE ILLUSTRATED EMBODIMENTS

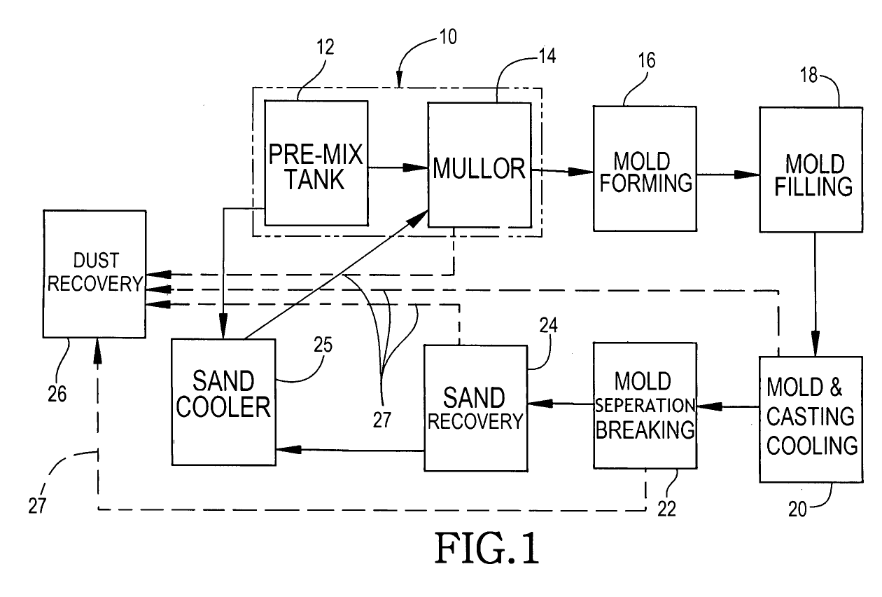

A sand system of the invention, for making foundry sand mixes, includes a sand mixing system 10, outlined by a box defined by short and long line segments in FIG. 1. Sand mixing system 10 includes a pre-mix tank 12 and a mullor 14 or other sand mixing apparatus. Water and particulate bond material are mixed together in pre-mix tank 12 to form a pumpable slurry. The slurry is pumped or otherwise conveyed to mullor 14 where the slurry is used in making up a foundry sand mix. Typically, the slurry represents a make-up quantity of bond material and part of the make-up quantity of water, typically not all of the water, which are added to a charge of return sand which is being reused as described hereinafter. A make-up quantity of fresh sand is also typically added to the mixture in mullor 14.

Still with reference to FIG. 1, from the mullor, the sand mix is fed to mold forming apparatus 16. The molds made at mold forming apparatus 16 are thence conveyed to mold filling apparatus 18 where molten metal is poured into the molds with use of mold cores as needed. The filled molds, and the metal contained therein, are then cooled by mold and casting cooling apparatus 20. Apparatus 20 can be, for example, a slowly moving conveyor belt, or other holding area where heat can be readily dissipated from the molds and the poured metal. Once the metal has cooled sufficiently, the molds are preferably vibrated, and are thus broken away from the cast metal parts at mold separation and breaking apparatus 22. Sand and entrained bond material, from the broken molds, then enters the sand recovery subsystem 24. Spent sand, spend bond, and other waste, are separated out, and the remaining sand composition is returned, optionally through one or more surge receptacles (not shown), to sand cooler 25, and from the sand cooler to mullor 14 for re-use. The solid-line arrows between the boxes in FIG. 1 indicate the general directions of flows of the sand mix materials and the sand mix.

Various of the work stations identified above generate substantial quantities of dust. A dust recovery system 26 collects dust from the several work stations such as through dust conveying conduits/piping illustrated by dashed lines 27 in FIG. 1, typically receiving dust from e.g. the mullor or other mixer, the mold casting and cooling activity, mold breaking and separation, and the sand recovery subsystem. Dust can be collected from more, or fewer, areas of the foundry dust ducts than those illustrated. Such dust, and its representation of waste in foundry operations, as well as quality of the sand mix, and the affect of the sand mix on the quality of the molded metal products, is the focus of this invention.

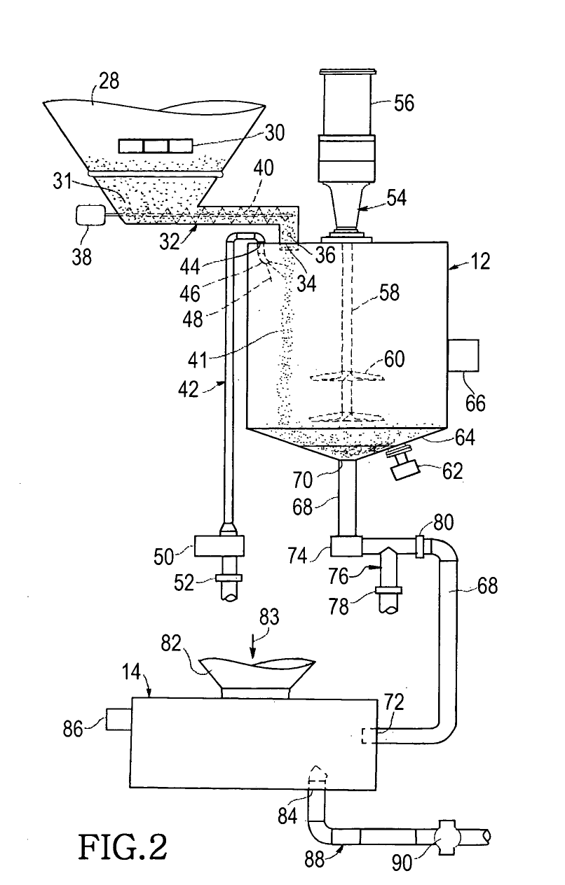

Reference is now made to FIG. 2 and a more detailed description of sand mixing system 10. As seen in FIG. 2, a bond hopper 28, including a vibrator 30, feeds bond material 31 by gravity into e.g. a screw conveyor 32 which leads to a bond material entrance port 34 at the top of pre-mix tank 12. One or more photoelectric eyes 36 at or adjacent the entrance port detect the presence or absence of bond material falling through the entrance port into tank 12. If screw conveyor 32 runs for a preset period of time without an eye 36 detecting bond material, an alarm can be activated, or the mix cycle can be shut down for operator attention. A drive motor 38 drives screw 40 in screw conveyor 32, thus to convey the particulate bond material from the bottom of hopper 28 to bond entrance port 34, thence for dropping the bond material by gravity, past photoelectric eye 36 for detection, and thence as a stream 41 of particulate bond material into tank 12 through the entrance port across an open space downwardly to e.g. an underlying pool of water, or previously added mass of bond material or previously made-up slurry.

A water supply line 42 feeds water into pre-mix tank 12 through water entrance port 44, which water entrance port is preferably positioned proximate bond entrance port 34 for reasons which will become clear as the description continues. Water supply line 42 leads to a nozzle 46 which is positioned, and so configured, as to apply a finely divided spray of water 48 onto falling stream 41 of bond material particles entering the pre-mix tank, so as to apply a spray of water particles to the bond material particles as the bond material enters the pre-mix tank.

Nozzle 46 can be any nozzle which can apply a gentle, well dispersed spray of water to the falling bond material particles, so as to wet the bond material particles with sufficient gentleness as to not greatly divert the falling stream of particles, but with sufficient force to project the water droplets onto the bond material particles. Exemplary of such nozzles is a VeeJet® nozzle having a capacity of 20 gallons per minute at 40 psi, and having 95 degree spray angle, supplied by Spraying Systems Company, Wheaton, Ill.

Thus, the surfaces of the bond material particles are wetted by the time they get to the bottom of the tank. Such wetted particles are significantly heavier than unwetted particles, thus reducing tendency for the bond material particles to move laterally or upwardly in tank 12 and thus to become, or remain, air borne because of any agitation to which such particles might be subjected. Further, such wetted particles accordingly acquire increased surface tackiness properties in combination with such wetting, whereby the particles tend to stick to other surfaces, for example other bond particles or the inner surface of pre-mix tank 12. This increased tackiness thus further reduces the probability of such particles becoming air-borne. Preferably, the wetted particles drop into or onto an existing underlying pool of water or into or onto an underlying body of previously-prepared slurry.

Water supply line 42 further includes water meter 50 for assistance in measuring, recording, and controlling the quantity of water which enters tank 12 through the water supply line. Use of meter 50 is optional in that other methods of measuring, recording, and controlling the quantity of water can be employed.

Water supply line 42 includes valve 52 for isolating the pre-mix tank from the water supply system, for example the city water supply, or a private well supply.

Still referring to FIG. 2, a mixing device 54 extends from an externally-mounted mix motor 56 along a drive shaft 58 to a pair of sets of mixing blades 60. Blades 60 are positioned along the length of shaft 58 to provide for thorough mixing of the water and bond material in the tank, thus to thoroughly disperse the bond material in the water and to make a thoroughly blended slurry of the bond material and water. Any combination of drive motor, shaft, and blades can be used as mixing device 54 so long as the combination provides for thorough dispersal and wetting of the bond material, and generally uniform mixing of the bond material with the water. An exemplary suitable mixing device is a Braun Mixer Model BD75-900, available from Gillette Company, Boston, Mass. The illustrated mixing device shows two mixing blade sets, an upper blade set and a lower blade set. More or fewer blade sets can be used depending on the height/head which is anticipated to be commonly encountered during mixing of a mixture/slurry in the tank. Blades 60 should be arrayed along shaft 58 so as to be immersed in the mixture of water and bond material for a substantial amount of the mixing time after full and typical charges of water and bond material have been added to pre-mix tank 12.

Pressure transducer 62 is mounted at bottom wall 64 of pre-mix tank 12. Transducer 62 can, in the alternative, be mounted to the side wall of tank 12, anywhere below the slurry level to be sensed as a trigger level. To the extent the transducer is mounted on the side wall, preferred locations are at or adjacent the bottom of the side wall. Transducer 62 senses the downward force exerted on the bottom wall of the tank by the weight of water and bond material in the tank, and sends suitable signals to pre-mix controller 66, through connecting communication lines (not shown), such signals pertaining to the quantity/weight of material in the tank.

Controller 66 is preferably a programmable logic controller, such as a user programmable Siemens S7-200PLC available from Professional Controls Corp, Germantown, Wis. Another option is an Allen Bradley model SLK505 PLC.

A discharge line 68 extends from discharge port 70 of the pre-mix tank to slurry entrance port 72 on mullor 14, where the slurry is delivered to the interior of the mullor receptacle. Slurry pump 74 pumps the slurry along discharge line 68 to the mullor. Exemplary of suitable slurry pumps is model T8/WAPB/NE/NE/NE available from AAAnderson, Waukesha, Wis. Another option is a Gould JC IJ-2×3-11 slurry pump.

A drain tap 76, having a cut-off valve 78, preferably leads to a drain downstream of pump 74, for cleaning tank 12, pump 74, and the upstream portion of discharge line 68. In the alternative, cleaning fluid from tank 12 and line 68 can be drained into mullor 14 and used in a batch of sand mix which is subsequently prepared in the mullor. Still further, tank 12, pump 74, and discharge line 68 can be cleaned in combination with cleaning the interior of mullor 14. In some embodiments, two pumps 74 are located in line 68, in parallel, such that a second pump can be pumping slurry while the first pump is off-line e.g. for maintenance; correspondingly the second pump can be off line for maintenance or rebuild while the first pump is pumping.

An isolation valve 80 is positioned downstream of drain tap 76, for the purpose of isolating pump 74 from mullor 14. A second corresponding isolation valve (not shown) can be positioned between pump 74 and discharge port 70 so as to fully isolate pump 74 from both pre-mix tank 12 and mullor 14.

Mullor 14 can be any conventionally available mullor such as the 100-B SPEEDMULLOR® available from the Beardsley and Piper Division of Pettibone Corporation, Chicago, Ill. Such mullor is typically used for a batch mixing operation, whereby sequential batches of sand mix are made as needed, in support of the mold forming operation in the foundry. In a batch operation, mullor 14 is generally emptied after making each batch of sand mix. Mullor 14 as shown includes the usual return sand entrance port 82 in the top wall of the mullor for receiving return sand from the mold separation and breaking apparatus 22, through sand recovery subsystem 24, as suggested by downwardly-directed arrow 83 in FIG. 2. Sand recovery subsystem 24 is represented in FIG. 2 by the large return pipe at sand entrance port 82. Mullor 14 further includes the usual fresh water entrance port 84 where make-up fresh water can be added to the mullor.

A typical conventional mullor such as the SPEEDMULLOR® referred to above does not have a slurry entrance port 72. Thus, where a slurry system of the invention is added to a mullor which has already been installed in a foundry, such entrance port needs to be fabricated in the foundry at the use site. In the alternative, such entrance port can be specified to the mullor manufacturer when the mullor is purchased as a new machine.

In a typical foundry operation, the combination of mullor 14, mold forming apparatus 16, mold filling apparatus 18, mold and casting cooling apparatus 20, mold separation and breaking apparatus 22, sand recovery subsystem 24, and sand cooler 25, operate as a generally cycling system, wherein sand and bond material are re-used with routine withdrawal of a replenishment amount of used sand mix which is typically discarded to landfill. Fractions of both the bond material and the sand are lost due to inefficiencies of the system as well as to intentional withdrawal of the replenishment amount of sand mix, and must be replenished with fresh sand and fresh bond material, along with suitable quantities of water.

Fresh sand can include regenerated sand. As used herein “regenerated” sand refers to sand which has been processed after recovery from e.g. the molding activity, such as by washing and sizing to pre-determined specifications.

Fresh bond material can include regenerated bond material particles. As used herein, “regenerated” bond material refers to bond material particles, e.g. from dust collection, which have been processed after recovery from e.g. the molding activity or dust collection, such as by separating out the non-clay particles in e.g. a settling tank.

In addition, worn out fractions of both the sand and the bond material are routinely removed from the sand system and replenished with fresh sand and bond material. Exemplary of such worn out fractions of sand and bond material is the burned-out portion of the sand/bond composite at and adjacent the metal/sand interface in the mold. Other worn out sand is commonly found in the core sand.

For example, typical sand molds are substantially more massive than the metal parts which are cast in such molds. Accordingly, the portion of the sand in the mold which is close to the poured metal, e.g. within 1-2 inches of the metal in the mold, is damaged, e.g. burned out, by the heat of the liquid metal and should be discarded when the mold is subsequently broken away. However, a significant fraction of the sand is not damaged, and can be reused to the extent such sand can be recovered and returned to the sand mix system, where the sand is reconditioned, including conditioning in a sand cooler and in the mullor, by addition of fresh bond material, fresh sand, and water, for subsequent use in the sand system.

Typically, a portion of the bond material which remains mixed in with the returned, damaged sand is similarly damaged by the heat of the poured metal, and should similarly be discarded. Again, a substantial fraction of the bond material used to make a mold is satisfactory for re-use after being used to make a mold, and after the bond material is subsequently reconditioned in the sand mix system.

Consistent with the above discussion of recycling of the sand and bond material, a typical ongoing sand system operation comprehends that, for a given size sand mix batch, a substantial fraction of the mass of the sand and bond material used in the batch is return sand which has been returned to the mullor from the metal casting operation, through sand recovery subsystem 24, for re-conditioning and re-use. For example, a 6000 pound (2721 kilogram) batch of sand mix mixed in mullor 14 includes about 5600 pounds (2540 kilograms) of return sand mix, about 200 pounds (91 kilograms) of fresh sand introduced directly into the mullor, and about 200 pounds of a slurry introduced directly into the mullor from the pre-mix tank. The slurry comprises about 150 pounds (68 kilograms) of fresh water and about 50 pounds (23 kilograms) of fresh bond material, which represents a bond/water ratio of 1/3. The bond/water ratio can be made up at a ratio of less than 1/3 by adding more water in the pre-mix tank, so long as the added quantity of water is tolerated by the sand system. A weight ratio greater than 1/3 can be used so long as the resulting slurry remains sufficiently fluid to be readily pumped by pump 74. The range of bond/water ratios typically used in foundry operations is about 1/16 to about 1/2. The lower limit suggested is merely exemplary of typical foundry operations, and is indeed not a functional limit. The upper limit suggested is more functional in that the resulting slurry is to be pumped, and the higher the bond/water ratio, the greater the difficulty of developing a uniform bond/water mixture, and the greater the difficulty of pumping the resulting bond/water mixture.

Thus, for a 6000 pound batch of sand mix, the quantity of sand lost in the sand subsystem operation, both from inadvertent losses and from sand intentionally discarded to landfill from e.g. the surge tanks, and which is replenished in the sand mixing activity, is about 200 pounds of sand. Correspondingly, the quantity of bond material lost in such sand subsystem operation is about 50 pounds of bond material. Accordingly, the weight ratio of fresh bond material to fresh sand is about 1/4. Such ratio can vary from foundry to foundry, whereby a higher ratio such as 1/2 or 1/3 may be experienced as appropriate in some foundries, and a lower ratio such as 1/5 or 1/6 may be experienced as appropriate in other foundries.

The exact quantities and proportions of all the various sand mix ingredients vary widely, depending especially on the quantity and condition of the return sand mix which is returned to mullor 14 by the sand recovery subsystem, as well as depending on the structure and operation of the dust control system. For example, where no return sand is available, several batches of slurry are pumped to mullor 14 in order to make up a full initial batch of sand mix. An important consideration in maximizing the value of the invention is the consideration that bond material entering the sand system enters the system as a water slurry through pre-mix tank 12.

In some foundry operations, the amount of water to be added to the mullor 14 limits the amount of pre-wetted bond, which can be added at mullor 14, to less than the needed amount of bond material, whereby the remaining needed amount of bond material can be added to mullor 14 in its dry particulate form. Such dry bond material does not benefit from the thorough wetting imparted to the bond material particles in pre-mix tank 12. As a result, the benefits of wetting as taught herein may not be imparted to that fraction, if any, of the bond material which enters the sand system through an avenue other than the pre-mix tank, and thus the full benefits of the invention may not be achieved, though some benefits will be achieved to the extent a portion of the bond material is fed to mullor 14 as a water slurry from the pre-mix tank.

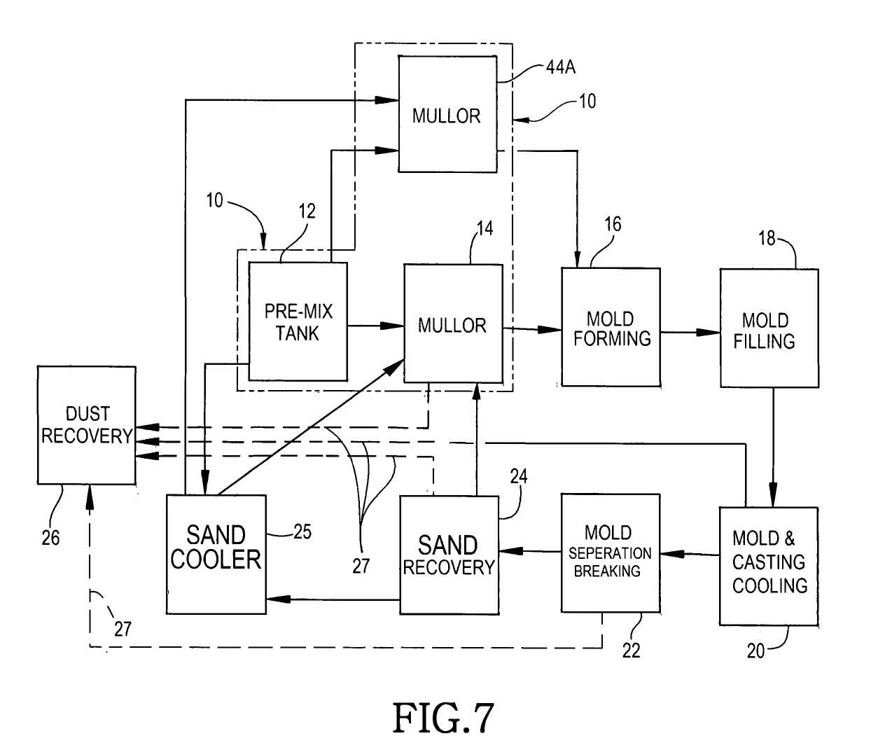

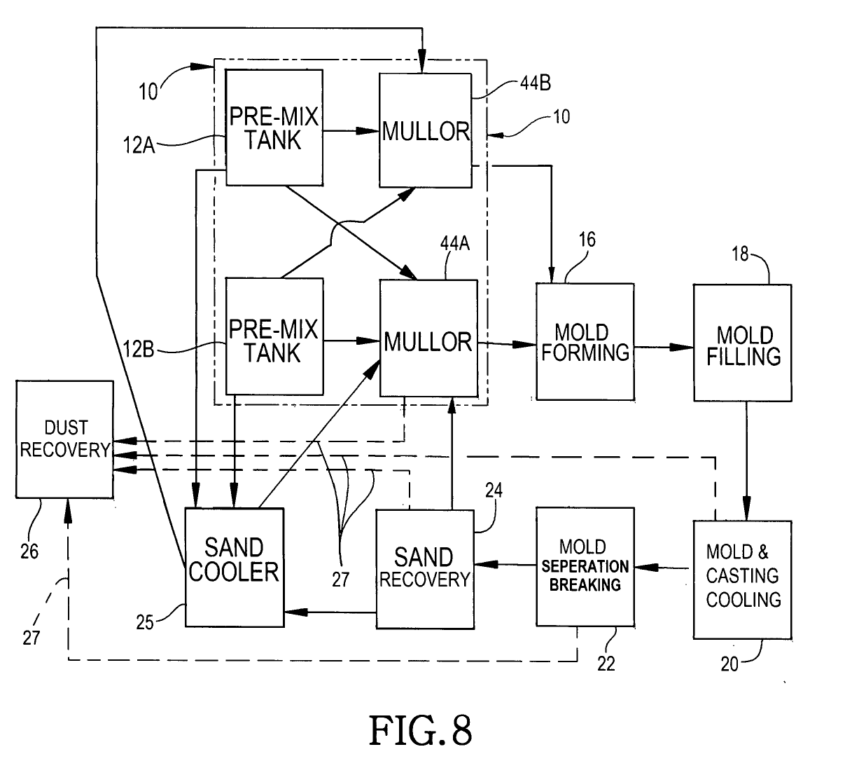

In the invention, rather than adding the remainder of the bond in dry particulate form, additional bond slurry can be added into the sand system at sand cooler 25. Thus, some or all of the plain water addition, which is conventionally added in the sand cooler is added as part of the bond slurry, in the sand cooler, in addition to the recited addition of bond slurry in the mullor. Turning to FIGS. 7 and 8, the slurry outlet from pump 74 can be fed, with suitable valving and/or pumping, both to mullor 14 and to a sand cooler which is upstream of mullor 14 in the foundry sand system. The bond addition system of the invention thus operates by adding pre-wetted bond in the mullor, up to the limit of the amount of water which can be added to the mullor. If still more bond is being required in the sand, the additional bond can be supplied, in slurry form, to the sand cooler, up to the limit of the amount of water which can be added to the sand cooler.

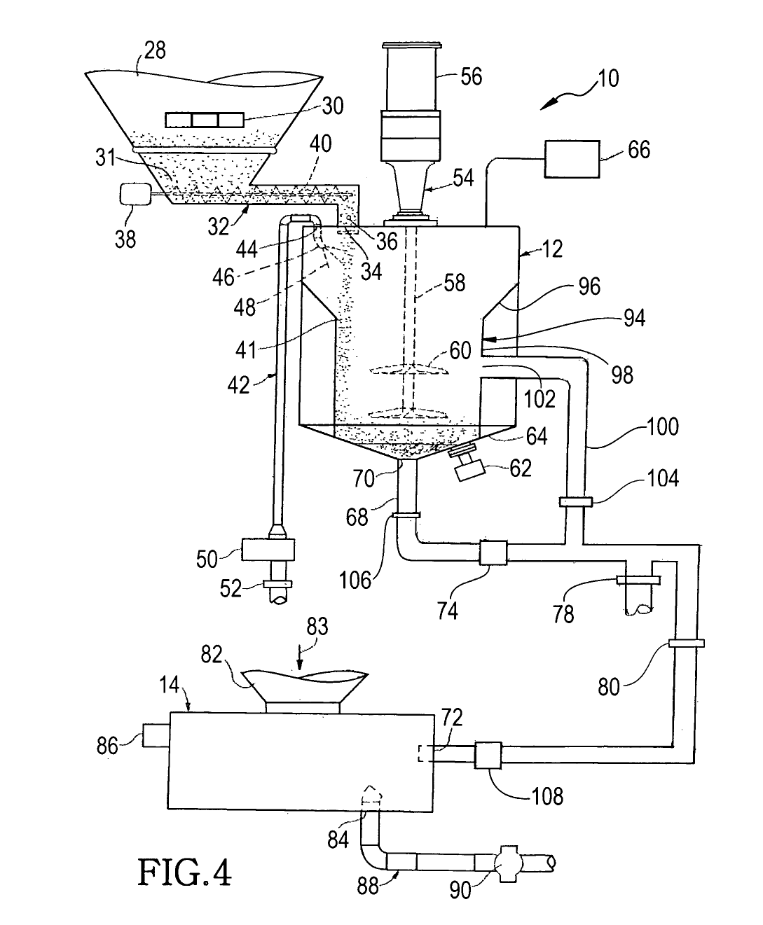

The apparatus and methods employed in the invention to provide the slurry of bond material and water to mullor 14 are preferably designed to operate in cooperation with an in-place conventional sand mix system, thereby to feed directly into a sand system already in place in an existing foundry. Thus, the pre-mix system receives commands from the existing conventional programmable logic controller 86 (FIG. 4) already in place as part of the conventional sand mix system. Such controller 86 controls entrance of return sand mix, fresh water, bond material, and fresh sand into mullor 14. Controller 86 can, if desired, be a controller as described above for controller 66, properly programmed to carry out the functions normally carried out for conventional mixing of sand, and suitably modified, as appropriate, to accept feeds from the pre-mix system and to instruct controller 66 and/or to receive instructions and/or data from controller 66 pertaining to water and bond additions. Such modification is readily carried out by skilled programmers readily available to foundry operators.

Typical inputs to controller 66 are, without limitation, as follows.
Water Increase, from controller 86
Water Decrease, from controller 86
Bond material increase, from controller 86
Bond material decrease, from controller 86
Photo eye 36 detect
Water Meter Pulse report
Pressure transducer, or other slurry level sensor, report
Bond/water needed, optionally including bond/water ratio

Typical outputs from controller 66 are, without limitation, as follows.
Water valve 52 open, closed
Discharge valve 78 open, closed
Pump valve 80 open, closed
Mixer motor 56 on, off
Bond feed drive motor 38 on, off
Vibrator 30 on, off
Pump 74 on, off

In general, any particulate bond material composition which is useful for making sand molds for foundry use can be mixed and formed into a useful slurry according to the pre-mix teachings of this invention. A typical bond material useful in foundry systems contemplated by the invention has particles which substantially all pass through a 200 mesh screen, and has the following composition.

| Material | Weight Percent |
|---|---|
| Seacoal | 24.7 |
| Western Bentonite | 54.9 |
| Cereal | 2.25 |
| Southern Bentonite | 15.7 |
| Soda Ash | .55 |
| Low Emission Coal | 1.9 |

The sand mixing system 10 operates generally as follows in an ongoing sand system operation. When controller 86 determines that a fresh batch of sand mix will be needed, at an anticipated future time, at mold forming apparatus 16, a desired and defined quantity of return sand is loaded into mullor 14 in the usual and conventional manner, with mixing at conventional times and durations, and at conventional speeds. Such return sand is typically more or less about 2 percent by weight water as the water enters the mullor, with variations depending on the specific design of the foundry of interest.

Typically, water and dry particulate bond additions are called for by conventional controller 86 for incorporation with the return sand mix in making up a fresh batch of sand mix. Controller 66 anticipates such requirement for water and bond material based on e.g. tests done on a recent previous batch of sand mix released from mullor 14, in combination with anticipated conditions of the return sand. In the invention, controller 66 signals the making up of a batch of slurry ahead of any demand from controller 86 for release of water and especially bond material. In the alternative, because the time required for making up a batch of the slurry is relatively short, the slurry can be made up after system controller 86 calls for bond material and water.

In any event, when the slurry has been properly prepared, and controller 86 has called for bond material and water, pre-mix controller 66 opens discharge line valve 80 and starts slurry pump 74. The quantity of slurry specified by controller 86 is then pumped to mullor 14. Since the quantity of slurry to be specified by controller 86 for a given mullor can be determined before the slurry is made up, the size of the slurry batch can be made to match the amount of slurry being requested by controller 86, whereby tank 12 can typically be emptied after the making of each batch. Fresh make-up sand is also added to the mullor, or elsewhere in the return sand subsystem, as needed.

The slurry and fresh make-up sand are mixed with the return sand mix in mullor 14 for the usual time of about 90 to about 120 seconds, so as to make up a fresh batch of uniformly mixed sand mix, including return sand mix, fresh sand, the slurry of water and bond material, and any additional dry particulate bond, ready for use in forming sand molds. Within the limits of the process, the slurry in make-up tank 12 is specified to include the full amount of replacement bond material needed, but less than the full amount of replacement water anticipated to be needed where and when possible. The balance of the replacement water, if any, is added in the mullor through water feed line 88. The finished sand mix is then discharged from the mullor and transported to the mold forming apparatus. The sand mix, as discharged from the mullor, typically comprises more or less about 3 percent by weight water.

A typical discharged sand mix of the invention has an overall AFS clay content of about 10.5 percent by weight, and active clay content of about 8.5 percent by weight. Active clay content can be determined according to standard Methylene Blue tests, AFS Procedure 2210-00-S or AFS Procedure 2211-00-S. The AFS clay content can be determined by the standard AFS Clay test, AFS Procedure 2110-00-S. All such tests are set forth in the Mold & Core Test Handbook, 3d Edition, published by the American Foundry Society, Des Plaines, Ill.

Typical range of AFS clay content in the sand mix discharged from the mullor is about 5 percent by weight to about 15 percent by weight AFS clay. Preferred AFS clay content is about 10 percent by weight. By using the pre-mix step of the invention, the AFS clay fraction in the reconditioned discharged sand mix, discharged from the mullor, can be reduced by at least 0.5 percent by weight, typically by at least 1.0 percent by weight because of the thorough wetting of the fresh bond material, whereby the primary source of active bond material which has latent but ineffective potential for forming bonds is bond material from the return sand used in making up the batch of sand mix. Since a high fraction of the fresh bond material is sufficiently wetted in the pre-mix tank to be able to form bonds, the conventional allowance for unwetted fresh bond material is obviated, whereby the quantity of fresh bond material can be reduced by up to the amount of the conventional allowance for unwetted fresh bond material. Thus, sand mixes of the invention can contain a smaller fraction of bond material while retaining suitable bond-forming properties.

Accordingly, for example, where a particular foundry operation typically uses sufficient bond material to provide clay content of 10.5 percent AFS clay content in the sand mix, the AFS clay content can be reduced to no more than about 10.0 percent by weight, and typically can be reduced to about 9.5 percent clay, or less, and still achieve the desired results in conventional compactability and green strength tests.

As another example, where the AFS clay content is e.g. 10.5 percent by weight and active clay content is 8.5 percent by weight, using conventional mixing methods, a two percent by weight allowance is commonly made in the fresh bond addition, for free bond clay material. Using the invention, such allowance can be reduced, or eliminated in specifying the quantity of bond material to be delivered to the mullor in the slurry.

Depending how much of the free bond clay is merely inactive as compared to being dead in the conventional process, the reduction in AFS clay content can be as much as 1.5 percent by weight of the overall sand composition, or even as much as 2.0 percent by weight. The actual reduction, and the absolute fraction of clay content, will vary from foundry to foundry according to the specific designs of the respective foundry, including the design of the sand system in that foundry, as well as the aggressiveness of the dust collection system in capturing dry particulate material.

In general, the amount of make-up bond material can be reduced by about 40 percent by weight based on bone-dry bond, with a typical reduction range, without limitation, of about 20 percent to about 60 percent by weight. Each foundry experiences its own unique reduction amounts as a consequence of the unique features of the operating conditions of that respective foundry.

In a typical foundry operation, a batch mullor is kept continuously busy making sand mixes, with a sand mix being discharged e.g. about every 90-120 seconds. Accordingly, the pre-mix tank must be ready to provide a slurry mixture to the mullor at the same intervals. Since the bond material and water can readily be fully mixed to make a satisfactory slurry at such intervals, pre-mix tank 12 can be sized to produce a batch volume of slurry corresponding with the size batch of slurry material commonly requested by controller 86. Thus, assuming pre-mix controller 66 is operating in automatic mode, as soon as a batch of slurry has been delivered to mullor 14, controller 66 promptly starts to make another batch of slurry.

In that context, water spray is started at nozzle 46. The water spray is run alone for e.g. about 10-20 seconds to establish a fresh pool of water in the bottom of tank 12. Motor 38 and vibrator 30 are then started, whereby bond material feeds by gravity downwardly into screw conveyor 32 and the turning of the screw advances the bond material to bond entrance port 34, whereupon the bond material drops downwardly in a particulate stream as expressed by gravity across the open space between the top of tank 12 and the underlying material in the bottom of the tank. Such material can be, for example, only the freshly added water, or can also include a remaining portion of the previously made-up slurry.

As the bond material particles drop downwardly through the water spray emanating from nozzle 46, the finely divided spray of water coalesces on the bond material particles, whereby the weight of the water accelerates the downward fall of the particles and attenuates any tendency of such particles to deviate from the downward path due to patterns of air movement within the pre-mix tank. By breaking the water spray into finely divided particles, the water can be effectively added to the bond material particles while minimizing distraction of the bond material particles from their downward direction of traverse. Suitable such application of the water to the bond material particles can be achieved by the above described nozzle when operating at 40 psi water pressure and delivering about 20 gallons per minute of water. Where even finer dispersion of the water stream is desired, or where greater volume of water is needed, multiple nozzles can be arrayed about the location of falling stream 41 of bond material particles, thereby to deliver the desired quantity of water in multiple sprays.

Water and bond material continue to enter tank 12 until the pre-set water quantity (liters per minute or liters) and bond quantity (kilograms per second or kilograms) have been met. Controller 66 turns off motor 38, thereby stopping addition of the bond material to the tank, and turns off the water at valve 52 or meter 50 when the desired quantities of water and bond material have been delivered to the tank. Controller 66 turns on mix motor 56 to begin agitation, and corresponding mixing of the bond material and water in the tank. So long as the upper surface of the bond/water material mixture/slurry is above a pre-set mid-point level in the tank, mixer 54 optionally runs continuously to retain the bond material particles in suspension in the water carrier. Since the clay in the bond material, once suspended in the water, is readily held in water suspension, mixer 54 can run intermittently, as needed, to maintain such suspension.

When the slurry mixture is called for by controller 86, controller 66 opens valve 80 and starts slurry pump 74 to thereby deliver the desired quantity of slurry to mullor 14. As the upper surface of the slurry level drops below the pre-set level in the tank, mixer 54 is shut off. Typically, the pre-set level assures that all of the mixer blades 60 are beneath the surface of the slurry while the mixer is actively mixing the slurry.

The ratio of bond material to water in pre-mix tank 12 is about 0.5 pound to 4 pounds (0.3 kilogram to 1.8 kilograms) of bond material per gallon (3.8 gallons) of water. The lower end of the range generally represents a minimum quantity of bond material which is typically added to a sand mix. The upper end of the range represents a typical limit on the viscosity of the slurry which can be readily pumped by the contemplated class of pumps used at pump 74. In addition, an even higher bond material fraction can result in insufficient wetting of the particles of bond material. Typical compositions of the slurry as pumped from pre-mix tank 12 for a 6000 pound (2721 kilograms (batch of sand mix is about 16-20 gallons (60-75 liters) of water and about 30-60 pounds (13.6-27.2 kilograms) of particulate bond material.

A preferred ratio of bond material to water is about 2.5 pounds (1.1 kilograms) of bond material per gallon (3.8 liters) of water. In view of the above, a typical slurry of water and bond material is about 6 percent to about 33 percent by weight solids. Preferred solids content is about 23 percent by weight particulate bond material.

In the embodiments illustrated in FIG. 2, the usual fresh water line 88 to mullor 14 can be used to add part of the make-up quantity of water, whereby by coordination of controller 66 and controller 86, the water addition in pre-mix tank 12 can be minimized as desired to that minimum quantity of water which is required to enable efficient pumping of the slurry. To that end, the usual valve 90 on fresh water line 88 can be controlled by controller 86 in adding any desired quantity of fresh water to mullor 14.

In the automatic mode, an exemplary pre-mix control system generally operates as follows. Controller 86 relays to controller 66 the amount of water and bond material needed based on tests from one or more previous batches of sand mix discharged from mullor 14. Controller 66 issues appropriate commands and water is added through the water meter for 10 seconds before addition of bond material is begun. Bond material is added using the screw conveyor, which is calibrated to the number of turns of the screw for the desired addition rate. While the bond material is being added, vibrator 30 is also running on hopper 28, ensuring a continuous feed of the finely powdered bond material to conveyor 32. After the desired quantities of bond material and water have been added to tank 12, mixer 54 mixes the bond material and water whereupon the batch of slurry is ready to be added to the mullor. When the mullor/controller 14, 86 calls for a batch of slurry, controller 66 activates pump 74 and the pump runs until the desired quantity of slurry has been transferred to the mullor, for example by the making of a low limit switch according to such sensor as can sense the upper surface of the slurry in tank 12. A mid limit switch is pre-set to start and stop the mixer, running the mixer continuously only when the content level in the tank is at or above the pre-set mid level, so that the mix blades are not splashing the slurry about the tank.

Controller 66 then starts adding water for the next batch immediately after the transfer is terminated, e.g. pump 74 has stopped, and valve 80 has been closed. The cycle starts over, varying the quantities of water and bond material based on any adjustments directed by controller 86 or controller 66.

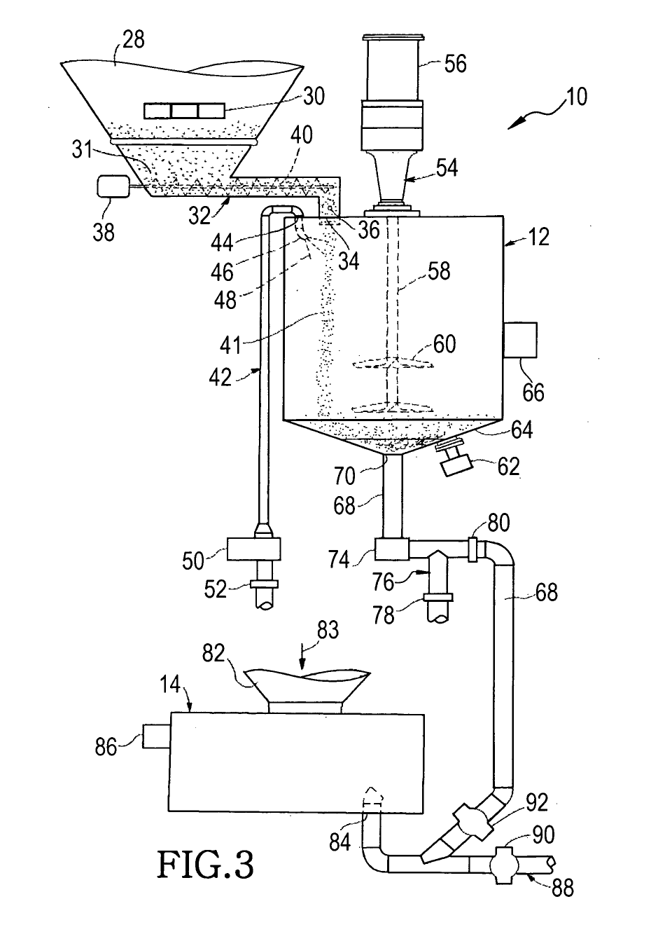

In an alternate embodiment, illustrated in FIG. 3, slurry line 68 from tank 12 feeds into fresh water line 88 upstream of mullor 14, rather than directly into the mullor, thus to begin the mixing of any fresh water with the slurry before the slurry enters mullor 14. Valve 92 is positioned on slurry line 68 proximate fresh water line 88 so as to provide for isolating the fresh water line from the slurry as desired. A significant advantage of the embodiments of FIG. 3 is that the slurry enters mullor 14 through conventionally-available water entrance port 84. In such case, the need to specify a slurry entrance port 72, or to cut or otherwise fabricate slurry entrance port 72 in the field, is obviated.

Whether the sand mix system is built according to FIG. 2 or FIG. 3, in either case, slurry line 68, and thus pre-mix tank 12, can be isolated from mullor 14 at will, so that the mullor can operate independently of the pre-mix tank as desired, e.g. while maintenance or repairs are being done on the pre-mix system. The pre-mix system includes tank 12, pump 74, the bond feed system, water feed system to tank 12, and the recycle system.

As illustrated above, the quantity of slurry mixture in a batch slurry system is based on that quantity of slurry needed for one batch of sand mix in the mullor. In the alternative, larger quantities of slurry can be made up, thus to service multiple batches of sand mix, either at a single mullor, or at multiple mullors, or to service one or more continuous mixers. Typically, each mullor 14 will have its own controller 86. The overall water requirement is fulfilled by the respective controller 86 bringing additional water into the mullor as needed, based on the water content of the slurry. Specifically, the slurry can be made with less than the quantity of water anticipated to be called for by any mullor controller 86, whereby the slurry can be used with any of a variety of water quantity requests from the respective controllers 86. The balance of the water requested at a particular mullor, and not contained in the slurry, is added to the mullor by command of the respective controller 86, through water entrance port 84.

In a conventional process, wherein the bond material is added directly to the mullor in dry condition, it is well known that a significant fraction of such bond material does not become sufficiently wetted in the mullor for the clay in the bond material to effectively form bonds with the sand particles. In addition, that bond material which has been e.g. “burned” in previously passing through the molding process so as to no longer be effective in forming such bonds, is known as “dead” bond material. Any bond material which holds capacity to form bonds between sand particles, and which is sufficiently wetted to form such bonds, is known as “active” bond material.

A typical sand mix discharged from mullor 14 is about 3 percent by weight water. A typical return sand composition, to mullor 14, is about 2 percent by weight water. Thus, the amount of water added to the composition in the mullor, including in the pre-mix slurry, is that amount necessary to cause the water content to be the desired, e.g. 3 percent, fraction for discharge from the mullor. The above percentages vary from foundry to foundry, within a well known range.

A given batch of sand mix in the mullor has a fraction of “dead” bond material, a fraction of “active” and properly wetted bond material, and a fraction of “inactive” bond material. “Inactive” bond material is bond material which is not able to actively form bonds between sand particles, but which can become active if properly wetted and otherwise brought into e.g. physical or physico-chemical interactive relationship with the sand.

The “dead” bond material is represented by those particles of bond material which do not actively participate in the bonding activity, and which will not participate in such bonding activity even when properly wetted. The “dead” bond material will not participate in the bonding activity under any feasible wetting conditions, and so its potential utility to the sand system is lost. However, the “inactive” particles can be made “active” under certain conditions and thereby become useful in the sand system.

Thus, a given sand mix typically contains “active” bond material, “inactive” bond material, and “dead” bond material. The combination of the “inactive” bond material and the “dead” bond material is that material which is “free” bond material, namely free from bonding activity. Such “free” bond material represents that bond material from which the user gains no bonding benefit.

The specific thrust of this invention is to provide operating conditions related to the bond material, which operating conditions attenuate or eliminate the fraction of the inactive bond material particles by activating substantially all bond material particles which are being freshly added to the sand system. Thus, for a given foundry operation, the invention adjusts the ratio of active and wetted bond material to “inactive” bond material in favor of an increased fraction of wetted and active bond material.

Further, in typical foundry operations, dust collector inlets are positioned close to many sources of air-borne dust sources, including at mullor 14. Dry particulate bond is a dust source because the bond is not wetted. Thus, a significant fraction of any dry particulate bond addition at the mullor is commonly lost to the dust collection system.

By using the pre-mix apparatus and methods of the invention, a much higher fraction, e.g. up to substantially 100 percent, of the fresh bond material particles are thoroughly wetted, and thereby do become “active” clay bond material and are not lost to the dust collection system. Such active fresh bond material becomes mixed in the mullor with the bond material in the return sand, some of which is active, some of which is inactive, and some of which is dead. The active bond material in the return sand in general is believed to remain active in the mullor and to leave the mullor in an active condition. A portion of the inactive bond particles in the return sand become properly wetted in the mullor, and thereby become active, so as to be able to form bonds with the sand.

By ensuring that such high fraction of the fresh bond material is properly wetted and thereby made active, one achieves certainty that substantially all fresh bond particles, which can be activated, are activated. Accordingly, and assuming substantially all fresh bond material particles can become active, the fraction of inactive particles in the fresh bond material is greatly reduced, e.g. down to substantially zero, whereby the overall fraction of the bond material leaving the mullor as inactive bond material is decreased, with corresponding increase in the fraction of bond material which is active, assuming a constant fraction of dead bond material.

Since an increased fraction of the bond material actively participates in the bonding activity, the quantity of bond material used, namely the bond/sand ratio, can be reduced, from a base quantity of bond material which would be used absent the invention, without reducing a specified level of bonding activity. Thus, the quantity of bond material, on a dry weight basis, used in a given sand mix, to achieve a given level of bonding activity, can typically be reduced in the invention by at least about 5 weight percent, based on the overall quantity of bond material added to the sand mix, from the quantity of bond material which must be used if the bond material is added to the return sand e.g. in the mullor, as dry particles. In some embodiments, bond material use can be reduced by as much as 10 weight percent or more, e.g. from 50 pounds of bond material using conventional dry bond-to-sand addition procedures, to 45 pounds of bond material using methods of the invention.

Especially where all of the bond is added to the sand system in pre-mix form, such as adding some of the bond slurry in the sand cooler, a 15 percent reduction in bond addition amount is readily achievable; while 20 percent to 30 percent, and up to 40 percent or more, reduction in bond addition can be achieved in some instances.

Those skilled in the art understand that the absolute amount of fresh bond addition, relative to the sand mix amount, for a given process, varies substantially depending on a number of factors in a given operation, including the specifications of the bond material, the specifications of the sand, the operating parameters which control the dust collection system, bond recovery from the dust collection system, and the like. So the first step in assessing use and/or efficacy of the invention is to establish a base line quantity of bond material, and resulting base line bond strength, by making a sand mix wherein conventional substantially dry particles of bond material are added to the return sand conventionally in a dry state, wherein water is subsequently added to the return sand, and the bond material and water are concurrently mixed with the return sand, all as is commonly done in conventional mullor operations. A bond material amount is thus established, which results in achieving a desired level of bonding activity in sand molds without using the invention.

Benefits of the invention are then expressed by using the methods and apparatus of the invention. If the same quantity of bond material is used, the mold strength is typically increased. However, mold strength increase is typically not desired. Rather, less bond material is used in obtaining the same base line level of bonding activity in the sand molds. Such reduction in quantity/fraction of bond material used in the overall sand mix is the e.g. 5 weight percent or e.g. 10 weight percent, 20 weight percent, 25 weight percent, 30 weight percent, 40 weight percent, reduction in the amount of bond material used, as referred to above. And since the level of bond strength desired in foundry sand molds is well established, the desired implementation of the invention typically results in obtaining a conventional base line level of bonding activity/mold strength in the molds while using a reduced quantity of bond material, whereby novel foundry sand mixes of the invention contain less bond material, e.g. about 5 weight percent to about 30 weight percent, optionally up to about 40 weight percent, less bond material, than conventional foundry sand mixes not of the invention.

Since less bond material is used in the sand system, less bond material is available for becoming entrained in the air and ending up in the dust recovery system. Bond particles which are not properly wetted in the mullor are lighter in weight, and less susceptible to forming bonds. Such insufficiently wetted particles are highly susceptible to becoming air-borne and entering the dust recovery system. A greater fraction of the bond material is thoroughly wetted in the sand mixing system of the invention. Thus, an overall smaller fraction, of the smaller amount of bond material particles in the discharged sand mix, is susceptible to becoming air-borne in the sand system. Collectively, the load on the dust recovery system is reduced, reducing the quantity of material which must be recovered and/or land filled from the dust recovery system, potentially reducing the quantity of escaped air-borne dust which is produced by the foundry operation, and reducing the quantity of bond material which must be purchased for use in the sand system.

In an exemplary conventional dust recovery system in a conventional foundry operation, about 35 percent to about 40 percent of the dust collected is clay from the bond material composition. Approximately 60 percent of the clay collected in the dust collection system is “active” clay, representing a loss of potentially useful bond material clay. By utilizing the pre-mix methods of the invention, the absolute quantity of clay lost to the dust recovery system is less, as is the fraction of the recovered clay which is “active” clay.

As used herein the phrase “pre-mix bond slurry” may not fit the classical definition of “slurry,” in that such mixture may not exhibit common liquidous free flow properties, and whereby suitable alterations are made to the apparatus and methods disclosed herein for transfer of the pre-mix composition from tank 12 to mullor 14. For example, pump 74 is specified according to the flow properties, e.g. viscosity, of the bond/water mixture which is to be pumped to mullor 14.

As used herein “active” bond material is bond material which has been properly wetted so as to be effectively used to bond together at least two particles of sand according to the methylene blue test.

As used herein “inactive” bond material is bond material which has not been sufficiently wetted to be effectively used to bond together at least two particles of sand but, if/when properly wetted can bond together at least two particles of sand.

As used herein “dead” bond material is bond material which cannot be effectively used to bond together at least two particles of sand even if properly wetted.

As described herein, the mullor is used as a mixing vessel for mixing the slurry with a primary charge of return sand, as well as any additional water and/or fresh sand. Those skilled in the art understand that a wide variety of mixing apparatus can be used for such mixing activity. The mullor described above is representative of batch-type mixers.

As used herein, a “batch-type” mixer is used to mix a predetermined quantity of foundry sand mix. The mixer is then emptied of substantially all of the sand mix before additional sand mix ingredients are fed into the mixer.

There can also be mentioned continuous mixers. As used herein, a “continuous” mixer, during ongoing foundry operations, continuously holds a charge of already-mixed sand mix, and receives and mixes additional sand mix ingredients any time the quantity of prepared/mixed sand mix falls below a predetermined set-point quantity. Thus, a “continuous” mixer/mullor continuously holds a quantity of already-mixed sand mix, ready for delivery to a mold line.

What is important is that the mixing apparatus satisfy the requirement that the sand, bond material, water, slurry, and other ingredients appropriate to foundry sand mixes, be suitably mixed for use in making foundry sand molds, at an appropriate composition, and in a timely manner, to meet the needs of the mold lines.

Similarly, the pre-mix tank is merely representative of batch mixers for making the pre-mix slurry. There can also be mentioned continuous mixers, and the like. As with the sand mix mixer/mullor, a “batch-operated” pre-mix tank prepares/mixes a predetermined quantity of slurry having a pre-determined composition, and a major portion, e.g. 75 percent of the slurry in the tank is discharged before additional slurry ingredients are charged into the tank. However, even in a batch-operated pre-mix tank, enough slurry is left in the tank to maintain prime on pump 74, such that the pump dose not run dry.

Also as with the sand mix mixer/mullor, a “continuous-operated” pre-mix tank continuously holds a charge of already-mixed slurry, and receives and mixes additional slurry ingredients any time the quantity of already-prepared slurry falls below a pre-determined set point quantity.

What is important is that the pre-mix apparatus satisfy the requirement that the bond material and water be suitably mixed for conveyance as a uniform mixture to the mixer/mullor apparatus which mixes the slurry with the remaining ingredients in an appropriate composition, and in a timely manner, to meet the needs of the sand preparation apparatus, whether the mixer/mullor or the sand cooler.

For mixing the slurry in tank 12, a head of at least about 12-14 inches is desired. In addition, the circle defined by the outer tips of mixing blades 60, as mixer 54 rotates shaft 58 and blades 60, should correspond to about 60 percent, e.g. 50 percent to 70 percent, of the projected surface area of the bottom of mixing tank 12 which projected bottom surface area serves to contain the slurry.

Referring now to FIG. 4, a certain projected size, no less than a certain minimum size, is desired at the top of tank 12 so that an operator or maintenance person can lower their head part-way into the tank to easily inspect the tank for cleanliness, or to work on or inspect the working elements in the tank. At the same time, since the quantity of slurry which is pre-mixed at any given time is relatively small, and given the benefit of maintaining a certain head in the slurry container, the lower portion of the slurry-containing chamber in the tank is necked down to a relatively smaller diameter in order to maintain the desired height of the head in the slurry. Thus, tank 12 as illustrated in FIG. 4, has an overall constant outer diameter top to bottom, while the inner chamber which receives and contains the slurry and slurry materials, has a relatively larger diameter upper portion and a relatively smaller diameter lower portion. The smaller diameter lower portion is generally spaced from the larger outer diameter of the tank by an internal baffle 94. Baffle 94 has a necked portion 96, and a lower generally vertical portion 98. Necked portion 96 extends at an acute downwardly directed angle from the outer wall of tank 12, namely at an angle which facilitates movement of water and bond material into the lower portion of the tank. The angle shown is about 35-40 degrees from vertical. Any angle which facilitates downward e.g. gravitationally-induced movement of the bond and water is satisfactory.

The lower portion 98 of baffle 94 intersects the necked portion 96 and extends to bottom wall 64 of the tank, thus to close off the space between baffle 94 and the outer wall of the tank whereby such closed off space is not entered by the bond material and/or water which is being mixed in the tank.

Still referring to FIG. 4, a recycle line 100 connects to slurry discharge line 68 between pump 74 and valve 80. Recycle line 100 extends between discharge line 68 and a return port 102 which is located in the side of tank 12 below the top of the slurry in the tank when a full charge of slurry is in the tank, below the set point in a continuously-operated pre-mix tank. A valve 104 is located in recycle line 100 between discharge line 68 and return port 102. An additional valve 106 is shown in discharge line 68 between pump 74 and discharge port 70 of the tank. A valve 108 can be used to further isolate mullor 14 from the sand pre-mix system.

With valves 104 and 106 open, and valves 78 and 80 closed, and pump 74 operating, the slurry in tank 12 is pumped as in a recycle process which adds to the agitation and working of the bond material in the tank. A certain amount of working of the bond material, so as to “activate” the bond material, is achieved by the action of mixing blades 60. The pumping action of pump 74 in processing the recycle stream of slurry provides additional working of the bond material, as does the forcing/movement of the bond material along the recycle path defined by piping 68 and 100.

Significant and useful activation of the bond material can be achieved by (I) the action of mixing blades 60 or (ii) the action of the recycle process through pump 74, either one operating alone. The use of both mixing blades 60 and the recycle stream is desired in order to achieve the collective benefits of both energy conversions, and an optimum level of activation of the bond material in the slurry in a short period of time.

The desired pumping rate of material in the recycle stream, when slurry is not flowing to the sand system, is at least as great as the pumping rate for transferring the slurry to the sand system. For example, an effective pumping rate for transferring the slurry mixture to the mullor can be about 15 gallons (56.4 liters) of slurry in 15 seconds. Accordingly, a similar pumping rate is effective for the recycle stream through piping 68, 100, while mixing such slurry, whether initially mixing the slurry, or temporarily holding a mixed slurry in a condition where such slurry can be used in response to a short-notice demand from a mullor 14.

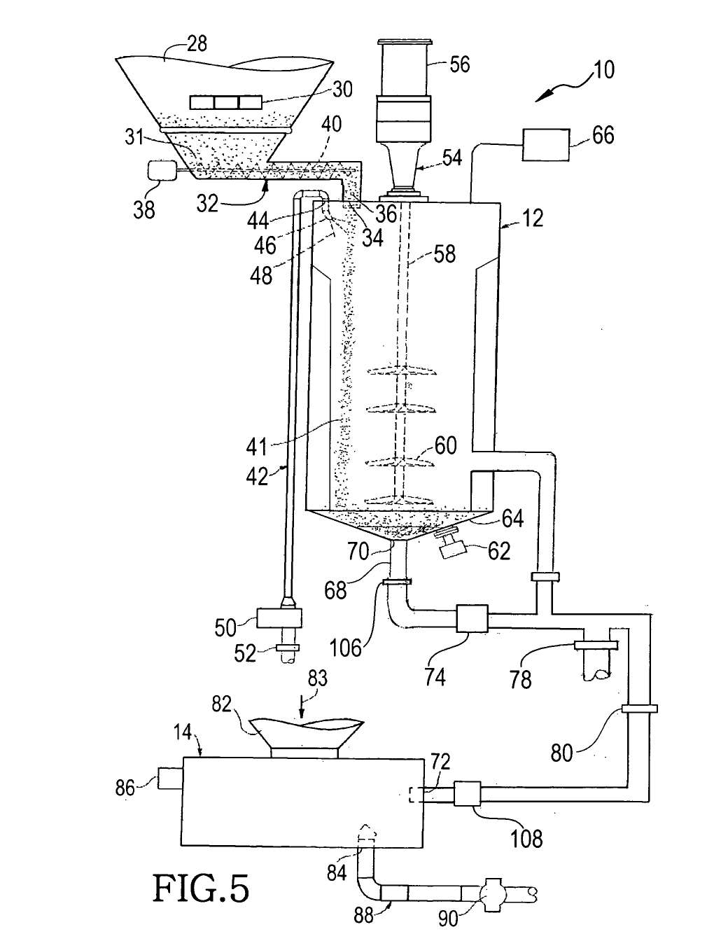

FIG. 5 shows a slurry-making system as in FIGS. 1-4, with the modification that tank 12 is increased in height so as to accommodate making a larger quantity of the slurry at one time. Such larger quantity of slurry may be expressed as a larger batch of slurry, e.g. in a batch process, or may be expressed as a tank which serves multiple mullors simultaneously, making batches of sufficient size to service the multiple mullors.

Tank 12 can function as a batch tank, for making individual batches of pre-mix slurry.

Tank 12 can function as a continuous, flow-through tank, as a continuous-flow mixer which replenishes the slurry material in the tank on a real time basis as slurry is withdrawn through discharge line 68 and past valve 80 to one or more mullors. Or water and bond can be replenished when the slurry level drops below a pre-determined set point level whereby the tank is not “empty” in terms of tank capacity.

Tank 12 can be set up through the control system, whether all through controller 66, or partially through controller 86, to service either batch mullors, or continuous mullors, or both. Especially where continuous mullors are serviced by tank 12, discharge pump 74 can optionally be specified as a variable speed drive pump, in order to match the feed rate of the pre-mix slurry to the demand rate of the respective one or more mullors. In some cases, multiple discharge lines are routed from the discharge from tank 12. For example, an individual discharge line can be run from tank 12 discharge to each mullor served by that tank, and each such discharge line has its own discharge pump, thereby to positively control the slurry pumping rate to the rate desired to the respective mullor.

In the alternative, individual discharge lines to individual mullors can be connected to discharge line 68 downstream of pump 74 and upstream of valve 108. Each such discharge line includes a gate-keeping valve, corresponding to valve 80, which enables slurry flow to the respective mullor on demand/command of the respective controller 66 or 86; and wherein the rate of such flow is controlled by e.g. a variable flow rate setting on the respective valve or by an intermediate flow-controlling pump or variable-gate valve in the respective discharge line.

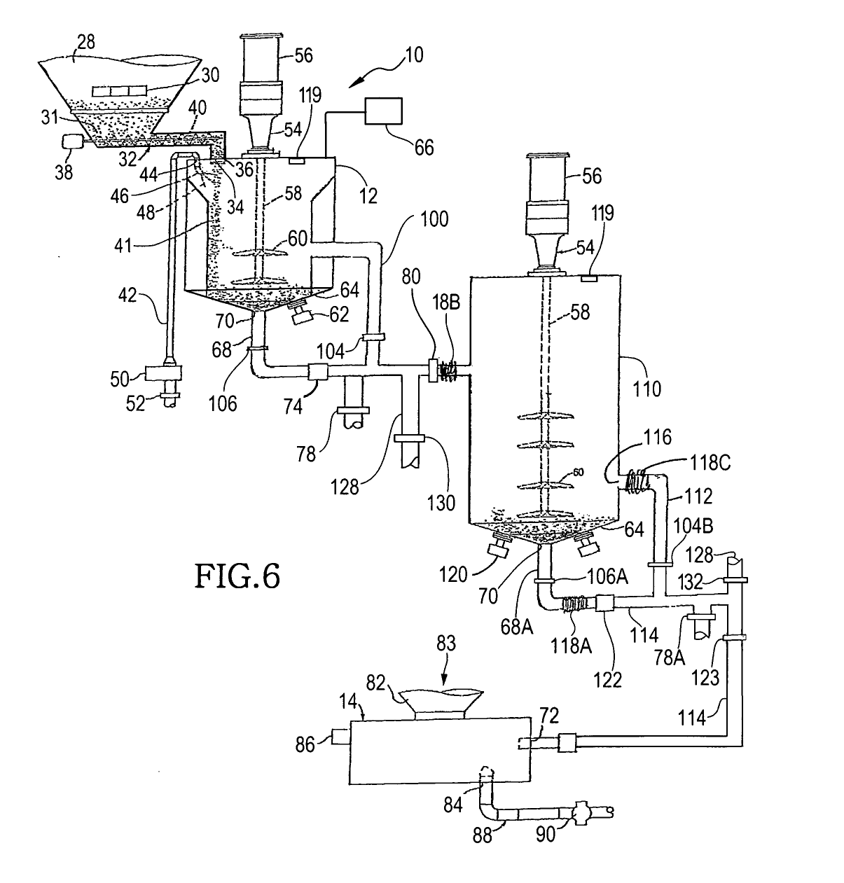

FIG. 6 illustrates use of an accumulator tank 110 between pre-mix tank 12 and mullor 14. Accumulator tank 110 can be used to temporarily store pre-mixed slurry, made in tank 12, before the slurry is called for by any mullor. A recycle line 112 extends from discharge line 114 to port 116 in the sidewall of tank 110. A first flex joint 118A in discharge line 114, a second flex joint 118B in discharge line 68, and a third flex joint 118C in recycle line 112, collectively, isolate the weight of tank 110 from the remaining hardware to which tank 110 is attached, thereby to enable load cells 120 at the bottom of tank 110 to sense the weight/mass of slurry material in the tank. Other types of sensors can be used to sense the level of the slurry in tank 110, for example level sensors, electronic beam sensors, a radar sensor 119, and the like, so long as the amount of slurry can be detected. A suitable radar sensor, available from Endress Hauser, through Crane Engineering Sales Inc., Kimberly, Wis., known as Levelflex M, can be installed inside the tank at the top wall of the tank, with a view directed downwardly toward the top surface of the slurry in the tank.

Such sensor is able to sense the distance between the sensing surface of the sensor and the top surface of the slurry in the tank, thus to enable controller 66, through a specific set of calculations based on e.g. dimensions of tank 12, to determine the amount of slurry in the tank. When such radar sensor, or other sensor, is used, load cells 120 and isolation joints 118A, 118B, 118C are not needed.

As the sand system requests bond/slurry, the slurry is fed to the sand system from accumulator tank 110. When the level of slurry drops below a pre-determined desired quantity/level in accumulator tank 110, additional slurry is added to tank 110 from pre-mix tank 12 to replenish the slurry in the tank. In this manner, accumulator tank 110 can be kept at a desired level of fill to meet the anticipated dynamic and changing bond requirements of the respective mullors which are active in the sand system.

A master controller (not shown) directly or indirectly controls/coordinates the actions of controllers 66 and 86, as well as all mullors, all pre-mix tanks, all accumulator tanks, and all other parts of the entire pre-mix system and the sand system. The master controller can, for example, be tasked with determining the most desirable pre-mix composition for the slurry coming out of the pre-mix tank, or out of the accumulator tank, especially where multiple mullors are being serviced by a given pre-mix tank.

In larger foundry operations, multiple pre-mix tanks can be used to provide for the demand of the foundry. Each pre-mix tank can be tasked with servicing a specified collection of mullors, for example 4 mullors, and optionally the associated sand coolers. The pre-mix tanks can be interconnected by the control system so as to feed only a specific group of mullors and/or sand coolers, or any mullor and/or sand cooler as specified by the control system.

Further, multiple pre-mix tanks can concurrently prepare and hold an equal number of different slurry compositions whereby the control system can make a real-time selection from among the already-prepared multiple different slurry compositions according to the needs of a particular mullor/sand cooler/sand stream.

In any event, an accumulator tank can be disposed in the feed stream between all mullors and/or sand coolers which can be fed by a particular pre-mix tank, between some but not all mullors and/or sand coolers which can be fed by a particular pre-mix tank, or any given accumulator tank can be connected to feed any and all mullors as directed by the control system, or the accumulator tank can be eliminated altogether.

Where the accumulator tank is eliminated altogether, then the pre-mix tank is sized to handle the capacity demanded by the collective number of mullors which are being supported by that particular pre-mix tank. Where a pre-mix tank feeds directly to multiple mullors, whether batch mullors or continuous mullors, or to a single continuous mullor, the flow rate of slurry which is demanded from the pre-mix tank can vary with time. Accordingly, discharge pump 122 is optionally specified as a variable speed drive pump. The speed of pump 122 is varied according to the demands of the respective mullors. Where feed is being requested from one or more mullors, pump 122 drives the slurry through discharge line 114 toward the respective mullor at the requested pumping rate. If no slurry is being delivered, pump 122 pumps the slurry through recycle line 112 at a rate which is conducive to enhanced activation of any inactive bond material in the slurry.

In the alternative, pump 122 can pump at a constant rate; and the rate of slurry feed to a given mullor is controlled by a variable-gate valve in the respective feed line between the pump and the respective mullor.

As yet another alternative, each slurry feed line between pump 122 and the respective mullor can have its own pump, for example a positive displacement pump, which acts, similar to a variable-gate valve, to control the rate of flow of slurry to the respective mullor.

FIG. 7 illustrates, in the type of block diagram form used in FIG. 1, the concept of a single pre-mix tank 12 feeding the pre-mix slurry to multiple mullors 14A, 14B and associated sand coolers. Only one sand cooler is shown. Those skilled in the art understand that the pre-mix slurry can be fed to more than one sand cooler in order to satisfy the bond requirements of the sand system.

FIG. 8 illustrates, in the type of block diagram form used in FIG. 1, the concept of multiple pre-mix tanks 12A, 12B feeding pre-mix slurry to multiple mullors 14A, 14B and associated sand coolers. Only one sand cooler is shown. Those skilled in the are understand that the pre-mix slurry can be fed to more than one sand cooler in order to satisfy the bond requirements of the sand system. While each pre-mix tank in FIG. 8 shows a single outlet line to a single mullor, any pre-mix tank can be set up to feed any of an array of mullors, and the piping can be set up so that the flow-through feed connections can be changed at any time, in real time, by closing and opening the appropriate set of valves such that any of the pre-mix tanks can feed any of the mullors. In addition, only one sand cooler is shown. Those skilled in the art understand that the pre-mix slurry can be fed from either pre-mix tank to any sand cooler in order to satisfy the bond requirements of the sand system.

Accumulator tank 110 is particularly useful where the pre-mix tank is being used to supply slurry to multiple mullors. For example, where multiple batch mullors are being supplied by the pre-mix tank, prepared slurry can be fed to accumulator tank 110 on an intermittent basis, held temporarily in the accumulator tank, and released at times and in quantities as requested from the respective mullors.

In such a system, where more than one mullor is being fed pre-mixed slurry by a pre-mix operation as at tank 12, the master controller is connected for communication purposes to the operations related to pre-mix tank 12, the respective mullors 14, any accumulator tank 110, and any other sand system elements which are fed by or affected by the pre-mix system, and can be tasked with specifying the bond/water relationship in tank 12, the quantity of pre-mix slurry to be fed from tank 110 to a respective mullor, and the timing and rate of feed of the slurry to a respective mullor. Thus, tank 110 can be used as an accumulator tank to feed a single batch mullor, multiple batch mullors, a single continuous mullor, multiple continuous mullors, or any combination of batch and continuous mullors, as well as corresponding sand coolers.

Accumulator tank 110 can be used in a similar manner where continuous mullors are being supplied from the accumulator tank. Thus, delivery pump 122 can continuously recycle the mixed slurry through delivery line 114 and recycle line 112. When slurry is demanded by/for a mullor, valve 123 (FIG. 6) is opened to the extent needed to make the desired delivery of slurry material.

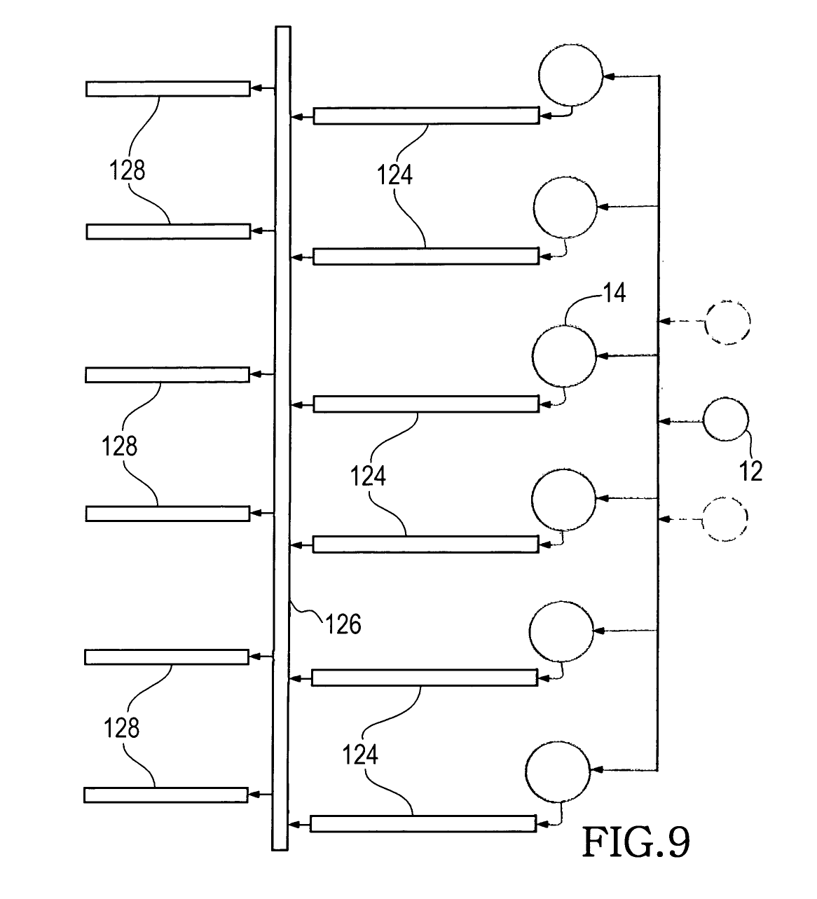

FIG. 9 is a plan view representation of an exemplary layout of a foundry system which uses one or more bond pre-mix tanks 12 of the invention. A first bond pre-mix tank 12 is shown in solid outline. Second and third tanks 12 are shown in the same vicinity in dashed outline. The number of tanks 12 can be determined by the user in concert with the specific plant design.

Pre-mixed bond slurry is fed from the respective tanks 12 through suitable valving and piping to any one or more, or all, of what are shown as six mullors 14 at the request of controller 86, optionally through an interface with controller 66 and/or utilizing the master controller which oversees the entire sand system operation. The sand mix discharge from each mullor feeds a sand belt 124 which transports the sand to a distribution belt 126 which feeds the sand mix to the respective mold lines 128.

As is well known in the art, the target quantities of water and bond, and also the bond/water ratio, which are to be added to the sand stream to make the desired sand mix, change frequently, such as with every batch of sand mixed in a batch mullor, or every 1-2 minutes in a continuous mullor. In addition, where multiple mullors are being run simultaneously, the demands from each mullor can be different. So long as the mixing rate/capacity of the pre-mix system can meet the mullor demands, quantity changes in mullor demand are readily met by simply pumping the desired quantity of slurry from the pre-mix tank to the destination mullor. Changing the bond/water ratio, and the rate at which the bond/water ratio can be changed, depends on the ability of the sand pre-mix system to readily adjust.

While ensuring a ready supply of pre-mixed bond is more readily assured using accumulator tank 110, the bond/water ratio is fixed by the time the slurry reaches the accumulator tank. Thus, there exists a potential tension in the system between (I) having a comfortable quantity of slurry made up ahead of time in accumulator tank 110 as in FIG. 6, (ii) the large quantity of pre-mixed slurry in tank 12 in FIG. 5, which has some limited capability to adjust the bond/water ratio, and (iii) the more rapid adjustment capabilities of the smaller pre-mix tank 12 in FIG. 4.

In general, the smaller tank 12 of FIG. 4 is used to make up individual batches, or a small-quantity continuous pre-mix such as enough to supply the sand passing through a single mullor, batch or continuous mullor, in a period of 1-3 minutes. Because the quantity of pre-mix slurry which is made up in tank 12 at any given point in time passes into the sand mix within 1-3 minutes, the pre-mix system can fully adjust to any change in bond/water ratio and/or slurry quantity, in that same period of 1-3 minutes. The exact response time depends on the actual amount of time over which the sand system absorbs the remaining pre-mixed slurry already in the pre-mix system, also considering the time required, typically 30 seconds to 60 seconds, to make up a batch of slurry in pre-mix tank 12 according to the slurry specifications newly presented by the control system. Thus, the reaction time to slurry specification changes is optimized e.g. with each batch in a batch mullor, or about every 1-3 minutes in a continuous mullor.

Turning now to FIG. 5, relatively larger tank 12 is sized such that the quantity of pre-mix slurry, which is typically readied in the pre-mix tank, is capable of servicing 2-4 batches of sand mix in one or more batch mullors, or 2-6 minutes of sand mix flowing through one or more continuous mullors. Accordingly, the response time of the pre-mix system which uses the relatively larger pre-mix tank of FIG. 5, is somewhat slower than the pre-mix system of FIG. 4, to respond to changes in the demanded slurry specification, while the system of FIG. 5 accommodates less intense management and control.

Finally, the pre-mix system of FIG. 6 accommodates the least intense management and control, and has the longest response time when the bond/water ratio specification changes.

In order to benefit from the greater holding capacity of the embodiment of FIG. 6, while benefiting from rapid response time achieved when feeding directly from the pre-mix tank, FIG. 6 further illustrates a by-pass system. The by-pass system enables the user to use accumulator tank 110 for routine operations and to use the by-pass to satisfy large step-changes in the bond/water specification such as at start-up of the sand system, or at product change-over. The by-pass system has a feed line 128 from the discharge of pump 74 between the pre-mix tank and the accumulator tank, controlled by valve 130. Feed line 128 feeds into discharge line 114 from accumulator tank 110 through valve 132 and ahead of valve 123, thus by-passing the accumulator tank in traversing from pre-mix tank 12 to a mullor 14.

The pre-mix system of FIG. 6 is generally operated as follows. As long as a fairly consistent molding operation is taking place on the mold lines, a controller, e.g. controller 86, issues an ongoing generally consistent series of requests/demands of the pre-mix system. Such requests for slurry are generally consistent as to quantity to be supplied in a given period of time, or for given batches. Such requests are also generally consistent regarding specification of the slurry which is to be supplied, such specification typically focusing on the bond/water ratio.

Pre-mixed bond slurry is made up and passed to accumulator tank 110 as required to maintain a generally constant level of pre-mix in tank 110, or to maintain the level within a desired minimum-maximum range of slurry levels. As such slurry is demanded for addition to the sand system, e.g. in the mullors, the demand is satisfied by drawing slurry from accumulator tank 110 as needed. For example, the pre-mix slurry can be replenished when a set-point level of slurry in tank 110 is reached as a result of a discharge from tank 110.

From time to time, controller 86 sends requests/demands asking for pre-mix compositions which cannot be readily satisfied with a draw from accumulator tank 110. Such demand can occur, for example and without limitation, at system start-up, during system shut-down, or when the mold line is being changed over to make a different metal product. The period of time, over which controller 86 makes request for such out-of-the-normal pre-mix compositions, is typically relatively short, and wherein subsequent slurry requests shift composition toward the more normal slurry composition, which more normal composition is already prepared, and being held, in accumulator tank 110.

When controller 86 first detects the need for an out-of-the-normal pre-mix composition, the computer compares the water content of the requested slurry composition with the water content of the slurry composition which is being held in accumulator tank 110. If the water content of the requested slurry composition is greater than the water content of the slurry in tank 110, the controller then considers whether water, or a high-water-content slurry, can be added to tank 110 thus to generate the desired slurry composition in a quantity appropriate to satisfy the instant slurry demand without jeopardizing potential for subsequently using any slurry which may remain in tank 110 after such draw/discharge. If yes, the water or high-water-content slurry is added to tank 110. If water alone is added to tank 110, such water can be added directly to tank 110 through a water port (not shown) in the tank, or can be added to tank 12 if tank 12 is operating in batch mode, and thence pumped to tank 110. If a high-water-content slurry is needed, the specified slurry is mixed up in tank 12. Valve 106 is opened. Valve 80 is opened. Valve 104 in recycle line 100 is suitably adjusted to direct the desired rate of flow of slurry to tank 110. Valves 78 and 128 are closed. Pump 74 is activated, pumping the slurry mixture into accumulator tank 110. Once the slurry transfer has been completed, valve 104 is opened and valve 80 is closed, thus re-directing any remaining slurry material into the recycle loop of tank 12. As appropriate, pump 74 can be deactivated.

Once the newly-mixed-up slurry arrives in tank 110, mixer 54 of tank 110 is activated specifically for the purpose of mixing the newly-added slurry composition with the slurry which had previously been in place in tank 110. While the slurry in tank 110 is being mixed by mixer 54, valve 106A is opened, and valve 104B is opened. Valves 132, 123, and 78A are closed. Pump 122 is started, thus activating the recycle stream in tank 110, through lines 68A, 114, and 112. The slurry is quickly mixed by the combined action of mixer 54 and the recycle stream into a generally uniform slurry mixture.

Once the slurry mixture is uniform, valve 104B is closed, and valve 123 is opened, re-directing the already-flowing stream of slurry through valve 123 and to mullor 14.

Where the bond slurry in tank 110 cannot satisfy the slurry specification demanded by the control system, and the bond slurry in tank 110 cannot be readily modified to satisfy the slurry specification, controller 86 activates the by-pass system through line 128. A quantity of pre-mix slurry, meeting the requested specification, is mixed up in pre-mix tank 12, using mixer 54 and/or recycle line 100 as desired. If the recycle line is used, valve 104 is open, valves 78, 80, and 130 are closed, and pump 74 is activated to move the bond and water through the recycle line until suitable mixing is accomplished, typically in a matter of 15-45 seconds.

Once the slurry is appropriately mixed, valves 123, 130, and 132, are opened. Valve 104 is closed. Valves 106A and 104B are closed. Pump 122 is off. Pump 74 is operating. The already mobile slurry is thus re-directed through by-pass line 128 through valve 130, through valve 132, through valve 123, and thence to mullor 14 at port 72.

As the by-pass line is used, controller 86 changes the specification of the bond slurry as needed in real time, batch by batch, or with ongoing changes to bond and water input in a continuous pre-mix tank system, until such time as the specification of the demanded composition can be met from the composition in tank 110, either directly or with readily available modifications e.g. through additions from the pre-mix tank to the accumulator tank. Once the composition in the pre-mix tank can be used, with or without modification, to satisfy the specification required by controller 86, valve 130 is closed, and valve 132 is closed. Valve 80 is opened if and as additions to tank 110 are contemplated. Valves 106A and 104B are opened, valve 123 is closed, and pump 122 is started, if use of the recycle line on tank 110 is contemplated. Once the required specification is reached for the slurry in tank 110, valve 123 is opened, re-directing the slurry toward mullor 14 at port 72. Any excess flow rate capacity of slurry, beyond that required by mullor 14, continues to circulate in recycle line 112. As desired, the speed of pumping, and thus the rate of output, of pump 122, can be slowed down to that rate of pumping which satisfies the requirements of mullor 14 while pumping little or no excess flow rate of slurry through the recycle line 112, thus saving wear and tear on pump 122.

Whenever slurry material is in tank 110, mixing device 54 in tank 110 is activated as often as necessary to maintain a generally uniform mixture of the bond and water. In addition, any time slurry or water is added to tank 110, the respective mixer 54 is activated for at least a minimum period of 1 minute in order to mix together the entirety of the contents of the tank, including thoroughly mixing the newly-added material with the material which had previously been present in the tank.

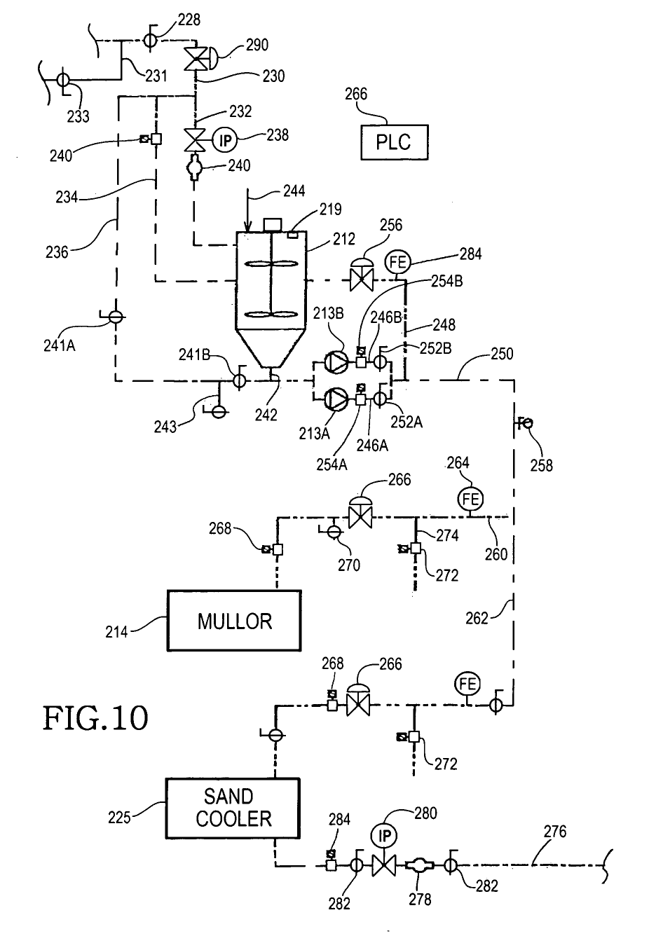

FIG. 10 shows a simplified illustration of use of a continuously fed pre-mix tank 212, continuously feeding pre-mix slurry, through first and second slurry pumps 213A and 213B, to a continuous mullor 214 and to a sand cooler 225. Water is fed from a main water supply through main shut-off ball valve 228 into main water feed line 230. The main water feed line divides into a main tank water line 232, a trim water line 234, and a back-fill water line 236.

Main tank water line 232 passes the water through a current-to-pneumatic valve 238 and water meter 240, and thence to pre-mix tank 212. Trim water line 234 feeds through a solenoid valve 240 to a second entrance port into tank 212. Back-fill water line 236 feeds through valves 241A and 241B into the outlet line 242 coming out of the bottom of pre-mix tank 212, and provides cleaning water for back-flushing tank 212 when the tank is cleaned.

Main water feed line 230 also feeds seal water, through feed line 231 which is upstream of valve 228, through valve 233, to pumps 213A and 213B. The seal water continuously flushes the pump seals with fresh water at all times the pumps are running, whether water is being supplied to the pre-mix tank or not, to control wear on the pump seals. A drain line 243, with ball valve, enables draining outlet line 242 from the pre-mix tank.

A bond feed line 244 in FIG. 10 generally represents structure similar to bond hopper 28, vibrators 30, bond material 31 and screw conveyor 32 of FIG. 2, which collectively feed bond material into pre-mix tank 212.

Pumps 213A and 213B are arranged in parallel, and receive the pre-mix bond slurry from pre-mix tank 212. Slurry is pumped by one, optionally both, of pumps 213A, 213B through first and second pump discharge lines 246A, 246B, which feed both recycle line 248 and sand system line 250. Valves 252A, 252B enable manual control of slurry flow through discharge lines 246A, 246B. Solenoid valves 254A, 254B enable computer control of the slurry flow through discharge lines 246A, 246B. Electric/pressure control valve 256 controls slurry pressure in recycle line 248. Pressure transducer 258, with pressure gauge, monitors and controls flow of slurry through sand system line 250.

Sand system line 250 divides into a mullor line 260 and a sand cooler line 262, which lead to mullor 214 and sand cooler 225, respectively. The control valving in both the mullor line and the sand cooler line are the same and so only the valving in the mullor line will be described. A magnetic flow meter 264 monitors and records rate of flow of slurry in the mullor line. An electric/pressure control valve 266 enables the control system to control the rate of flow of slurry through the mullor line. A solenoid valve 268 enables the control system to electrically completely close or open mullor line 260 to slurry flow. Ball valve 270 enables manual opening and closing of the mullor line. Solenoid valve 272 controls opening and closing of a drain line 274 from mullor slurry line 260.

In addition to the slurry lines which feed mullor 214 and sand cooler 225, the normal process water feed lines are also connected to the mullor and sand cooler in order to provide conventional process water to the mullor and sand cooler. The conventional process water feed lines to both the mullor and the sand cooler are typically structured the same, and so only the process water feed line to the sand cooler is shown, and only the process water feed line to the sand cooler will be discussed in any detail. To that end, a process water feed line 276 is shown in FIG. 10 feeding process water to sand cooler 225. Feed line 276 includes a water flow meter 278, an electric/pressure control valve 280, and isolation ball valves 282 which can be used to isolate water meter 278 and valve 280 from the rest of the water line. Finally, solenoid valve 284 can be used by the process control system to completely shut off flow of process water in feed line 276.

Controller 66 is shown in FIG. 10 without any representation of the connections between controller 66 and the respective system members which are controlled by controller 66. Those skilled in the art are well aware that suitable communications links connect controller 66 to the many elements of the system which are controlled by controller 66. Such links are typically wire-connections, but can be wireless in some environments. Thus, those skilled in the art are not further instructed by the addition of wiring between controller 66 and the respective elements. Thus, none is illustrated.

Further, those skilled in the art will recognize that any of controller 66, controller 86, and the master controller can be combined, or divided, in a wide variety of computing architectures. Accordingly, the illustrated and discussed control architecture is illustrative only, and not limiting so long as the operative functions of the system are accomplished.

Suitable electric/pressure control valves as at 256, 266 are Dia-Flo Diaphragm weir valves, 3200 Series, available from Fail Safe, Inc., Milwaukee, Wis.

Suitable electric/pressure transducer valves as at 258 are Metso Full bore Series 9000 flanged ball valves, available from FCX, Appleton, Wis.

A suitable magnetic flow meter as at 264 is available as Foxboro Model 801 HA-WCR-PJGFGZ-A from Crane Engineering Sales, Kimberly, Wis.

Returning to FIG. 10, the continuous feed pre-mix system operates generally as follows. Dry bond is fed to pre-mix tank 212, and mixed with water in a falling cascade as described earlier. However, in this continuous-feed embodiment, speed of addition of the bond is controlled by using a variable frequency drive motor to drive screw conveyor 32 at variable speeds consistent with the feed rate specified for the dry bond being fed into pre-mix tank 212. Water feed rate is controlled through weir valve 238, which operates on PID control logic. Water can, in the alternative, be added to tank 212 in batches, thus by-passing the need for the PID control logic. Overall, controller 66 ties the feed rate of dry bond and water to each other at a fixed bond/water ratio. Exemplary specific bond/water ratios are the same as those expressed for the batch-fed pre-mix process.

In general, the operation of continuously-fed pre-mix tank 212 is set up to provide a constant feed of slurry to the sand system any time the sand system calls for the slurry. At least one of pumps 213A, 213B is continuously pumping discharge slurry from the pre-mix tank toward mullor 214 and/or sand cooler 225 or through the recycle line. As a result, there is a constant flow of slurry from tank 212, whereby the slurry level is subject to being changed.

The draw-down which is drawn by the semi-continuous sand system can be managed by maintaining the slurry level within a pre-determined range of the full capacity of the tank. For example, controller 66 can maintain the quantity of slurry in the tank between 70 percent of full and 80 percent of full, with changes in bond and water feed rates set to maintain the amount of slurry at an intermediate set point, such as at 75 percent full.

In the alternative, controller 66 can add bond and water in batches, adding water and bond when the slurry level reaches a lower limit such as 70 percent full and shutting off flow of water and bond when the slurry level reaches an upper limit such as 80 percent full.

Controller 66 can monitor the level of slurry in tank 212 by e.g. level sensor 219, for example a radar sensor, in the pre-mix tank.

The water and bond in tank 212 are mixed, and maintained in a mixed condition, by activation of mixer 54. Mixer 54 can be cycled on and off as needed to mix freshly-added bond and water, or can be maintained in a constantly-on condition. The slurry is also circulated through one or both of pumps 213A and 213B, through recycle line 248. Such circulation, through recycle line 248, assists in activation of the bond particles. In some embodiments, the circulation through recycle line 248, alone, is adequate working of the bond particles to assure suitable wetting, and thus full activation, of substantially all of the “non-dead” bond particles in the pre-mix tank.

Pumps 213A and 213B are optionally each specified at full capacity to handle the maximum flow rate expected to be needed in sand system line 250. Accordingly, either pump alone can handle the requirements for pumping the slurry, whether as a recycle stream, as a stream to mullor 214 and/or sand cooler 225, or both process stream and recycle stream.

Pumps 213A and 213B are optionally driven by variable speed drives. In such instance, the user has the option of controlling the rate of flow through sand system line 250 either by manipulating valve 256 of the recycle line, or changing the output rate of the respective pump 213A or 213B. Either way, the rate of flow of slurry to mullor 214 and/or sand cooler 225 is controlled by e.g. controller 86 or controller 66, or both controllers 66 and 86 cooperate with each other in controlling the rate of slurry flow. Rate of flow is monitored by magnetic flow meters 264 in mullor line 260 and sand cooler line 262. When the control system detects no demand for slurry, the respective solenoid valve 268 closes, ensuring complete shut-off of slurry flow.

As a further control on rate of flow of slurry, pressure transducer 258 monitors pressure in sand system line 250 and feeds such pressure information to the control system. The control system accordingly commands changes in the setting of variable gate valve 256 in recycle line 248, thus to maintain a relatively constant rate of flow of slurry to the sand system, or to make a change in rate of flow of slurry to the sand system.

In the alternative, the control system maintains a constant rate of flow in recycle line 248, monitored by e.g. a magnetic flow meter 284, and varies the rate of output of the respective pump 213A, 213B in order to match the slurry demand, rate of flow, of the sand system. In such instance, pumps 213A, 213B can be run at less than rated speeds at least part of the time, thus reducing rate of wear on moving parts of the pumps, compared to controlling flow rates and pressures through the above-recited valve manipulation while the respective pump runs at full rated speed.

A potential limitation of the use of pre-mixed slurry is that the water demand of the mullor can be satisfied before the bond demand of the sand system is satisfied. Further, it is common to add about twice as much water to the sand system at the sand cooler as is added at the mullor. For example, in a system which handles about 6000 pounds (2721 kilograms) of sand mix over a given period of time, e.g. about 1 minute about 10 gallons/83 pounds (37.6 liters/37.6 kilograms) of water may be added at the mullor while about 20 gallons/166 pounds (75.2 liters/75/2 kilograms) of water may be added at the sand cooler.

To the extent the water addition demand is satisfied at the mullor before the bond addition demand is satisfied, no more slurry can be added to the sand in the mullor without potentially having a negative affect on the resultant sand product during the subsequent molding operations.

However, since water is being added in the sand cooler, since the spent/exhausted sand has already been removed from the sand stream by the time the sand reaches the sand cooler, by the time the return sand has reached the sand cooler, essentially all of the sand which will be removed from the sand system before returning to the mullor has already been removed. Thus, bond can be added to the sand stream at the sand cooler, to benefit. Accordingly, in any of the embodiments disclosed herein, any bond/slurry which cannot be added to the sand system at the mullor can optionally be added to the sand system at the sand cooler.

For example, sand typically enters the sand cooler at about 180 degrees F. to about 300 degrees F. and at about 0.5 percent by weight water to about 1 percent by weight water. Typically, the sand is specified to leave the sand cooler at about 120 degrees F. and about 2 percent water. Thus, in the sand cooler, heat is driven off and a net amount of water is added to the sand. The cooling is accomplished largely by evaporative cooling. The net water addition is accomplished by adding enough liquid water that a sufficient quantity of the water is retained in a liquid state to accomplish the desired quantity of water addition in the sand stream exiting the sand cooler.

In general, the slurry is made in the pre-mix tank with the minimum amount of water which is needed to capture, and to generally activate, the bond particles and to maintain adequate flowability of the resultant slurry. In some instances, for example where the full quantity of water to be added collectively in the mullor and in the sand cooler is passed through the pre-mix system, the full required amount of water is not needed in order to suspend the bond particles in the pre-mix tank. In such instance, the minimum amount of water needed to suspend the bond is added to the pre-mix tank and the slurry is made up. Then additional water is added to the pre-mix tank, as trim water through trim water line 234, with continued agitation of the slurry, whether through mixer 54 or active flow through the recycle line, or both, to mix the trim water with the initially made-up slurry. The resultant trimmed-back slurry is then fed in the required liquid proportions to both the mullor and the sand cooler.

In the alternative, the slurry can be fed to both the mullor and the sand cooler with a second water feed providing the additional water required in the sand cooler.

Still further, a first portion of the slurry can be fed, as initially mixed up, to the mullor, until the mullor water requirements are satisfied, and the remaining slurry trimmed back with trim water in the pre-mix tank, whereupon the trimmed back slurry is subsequently pumped to the sand cooler.

Another characteristic of the slurry is that viscosity of the slurry increases with time. Thus, when a slurry has been made up in the pre-mix tank and then is not used e.g. because of a delay elsewhere in the foundry, mixer 54 periodically agitates the slurry to keep the bond particles properly suspended in the water carrier. In addition or in the alternative, pump 74 continues to circulate the slurry through the recycle line. Finally, viscosity of the slurry can be monitored e.g. through the amperage draw of pump 74 in operating the recycle line. As viscosity increases with time, controller 66 instructs addition of trim water through trim water line 234, thus to maintain viscosity of the slurry within a range of viscosities which are susceptible of being pumped by pump 74, without exceeding the water requirements of the mullor and/or sand cooler.

Referring to FIG. 10, the back-fill water line 236 is available to dilute a slurry which is in danger of becoming too viscous to pump. For example, the slurry may leave tank 12 without being properly mixed; or the system may need to be cleaned. In any event, water is available, through the back-fill water line, directly to outlet line 242 and pumps 213A, 213B. In addition, back-fill water line 236 provides a fresh flow of water which prevents the pump from running dry while cleaning out the respective process lines such as lines 242, 248, 250, and the like.

In addition to the ball valve 228 shown in the main water line in FIG. 10, an additional valve 290, controlled by controller 66, can be employed in the main water line. If the liquid level in pre-mix tank 212 triggers an alarm as set in or by controller 66, controller 66 shuts valve 290.

Those skilled in the art will now see that certain modifications can be made to the apparatus and methods herein disclosed with respect to the illustrated embodiments, without departing from the spirit of the instant invention. And while the invention has been described above with respect to the preferred embodiments, it will be understood that the invention is adapted to numerous rearrangements, modifications, and alterations, and all such arrangements, modifications, and alterations are intended to be within the scope of the appended claims.

To the extent the following claims use means plus function language, it is not meant to include there, or in the instant specification, anything not structurally equivalent to what is shown in the embodiments disclosed in the specification.

Having thus described the invention, what is claimed is:

1. Apparatus for preparing bond for delivery to a foundry sand system in a foundry, said apparatus comprising:
(a) a pre-mix tank adapted and configured to receive thereinto particulate bond material and a liquid carrier therefore, to prepare a slurry of such particulate bond material and such liquid carrier, and to discharge such slurry from said pre-mix tank;
(b) a discharge line connected to said pre-mix tank at a discharge port, and adapted to receive such slurry from said pre-mix tank and to feed such slurry to a sand system in such foundry, further comprising a slurry discharge pump in said slurry discharge line; and
(c) a recycle line connected to said discharge line downstream of said slurry pump and connected to said pre-mix tank so as to convey a recycle stream of such slurry back to said pre-mix tank.

2. Apparatus as in claim 1, further comprising a mixer adapted to receive thereinto sand, liquid carrier, and bond material, as part of said foundry sand system, and to produce therefrom foundry sand mixes which can be bonded together by such bond material so as to be operable for making foundry sand molds, said slurry discharge line being connected to said mixer, and feeding such slurry to said mixer at a third feed port in said mixer.

3. Apparatus as in claim 2, including a water feed line feeding into said slurry feed line upstream of said third feed port.

4. Apparatus as in claim 1, including water spray apparatus associated with a second feed port in said pre-mix tank, said water spray apparatus being designed, configured, and positioned to apply a disperse spray of water onto a stream of bond material particles traversing an open space in said pre-mix tank.

5. Apparatus as in claim 1, including a pre-mix controller which controls quantities and timing of addition of water and bond material to said pre-mix tank.

6. Apparatus as in claim 1, including a bond material hopper, and a bond conveyor which conveys particulate bond material from said hopper to the first feed port in said pre-mix tank.

7. Apparatus as in claim 4, including a water line feeding said water spray apparatus in association with the second feed port in said pre-mix tank, further comprising a water meter in said water feed line which meters desired quantities of water to said water spray apparatus.

8. Apparatus as in claim 1, said pre-mix tank further comprising driven mixing apparatus adapted to mix such particulate bond material and such liquid carrier to thus form such slurry.

9. Apparatus as in claim 1, further comprising a level sensor adapted to sense a top surface of such slurry in said pre-mix tank.

10. Apparatus as in claim 1, said pre-mix tank comprising a bottom wall, and an upstanding outer wall extending upwardly from said bottom wall to a top of said pre-mix tank, and defining an outer perimeter of said pre-mix tank, and an inner wall, disposed inwardly of said outer wall, and extending upwardly from said bottom wall to a locus below the top of said tank, a first cavity thus being defined between said inner wall and said outer wall, and a second slurry-holding cavity being defined inwardly of said inner wall, said inner wall preventing liquid from traversing laterally outwardly from said second cavity to said first cavity.

11. Apparatus as in claim 6, further comprising a prime mover driving said bond conveyor, said prime mover comprising a variable speed drive adapted to adjust feed rate of such bond material in real time to said pre-mix tank.

12. Apparatus as in claim 1, said slurry discharge pump having a variable speed drive thus to vary the rate of discharging such slurry from said pre-mix tank to at least one of said recycle line and said sand system.

13. Apparatus as in claim 1 wherein said pre-mix tank is devoid of active powered mix apparatus inside said pre-mix tank.

14. Apparatus for preparing a foundry sand mix for use in a sand system in a foundry, said apparatus comprising:
(a) a pre-mix tank adapted and configured to receive thereinto particulate bond material and a liquid carrier therefore, to prepare a slurry of such particulate bond material and such liquid carrier, and to discharge such slurry from said pre-mix tank;
(b) a foundry sand system adapted to receive thereinto sand and such slurry, and to produce therefrom a foundry sand mix which can be bonded together by such particulate bond material thereby to make foundry sand molds;
(c) a slurry discharge line connecting said discharge port to said foundry sand system, and adapted to receive such slurry from said pre-mix tank and to feed such slurry to such foundry sand system;
(d) a slurry discharge pump in said slurry discharge line; and
(e) a variable speed drive driving said slurry discharge pump, and adapted to adjust feed rate of such slurry in real time to such foundry sand system,
whereby said variable speed drive can receive sequential real time drive speed commands from a control system, and adjust feed rate of such slurry to said foundry sand system to correspond with the drive speeds so commanded.

15. Apparatus as in claim 14, said foundry sand system comprising a mixer, adapted to receive thereinto sand and such slurry, and to produce therefrom a foundry sand mix which can be bonded together so as to be operable for making foundry sand molds, said slurry discharge line being connected to said mixer, and feeding such slurry to said mixer at a feed port in said mixer.

16. Apparatus as in claim 15, said sand system comprising a sand cooler, said slurry discharge line being connected to said sand cooler, and feeding such slurry to said sand cooler.

17. Apparatus as in claim 14, said sand system comprising a sand cooler, said slurry discharge line being connected to said sand cooler, and feeding such slurry to said sand cooler.

18. Apparatus as in claim 15, including a water feed line feeding into said slurry feed line upstream of said feed port in said mixer.

19. Apparatus as in claim 14, including a pre-mix controller which controls quantities and timing of addition of water and bond material to said pre-mix tank.

20. Apparatus as in claim 14, including a bond material hopper, and a bond conveyor which conveys particulate bond material from said hopper to a feed port in said pre-mix tank.

21. Apparatus as in claim 14, said pre-mix tank further comprising driven mixing apparatus adapted to mix such particulate bond material and such liquid carrier to thus form such slurry.

22. Apparatus as in claim 14, further comprising a recycle line connected to said discharge line downstream of said slurry pump and connected to said pre-mix tank so as to convey a recycle stream back to said pre-mix tank.

23. Apparatus as in claim 14, further comprising a level sensor in said pre-mix tank, adapted to sense a top surface of such slurry in said pre-mix tank.

24. Apparatus as in claim 20, further comprising a prime mover driving said bond conveyor, said prime mover comprising a variable speed drive adapted to adjust feed rate of such bond material in real time to said pre-mix tank.

25. A method of preparing a foundry sand mix, using return sand, a determined amount of fresh sand, a determined amount of fresh bond, and a determined amount of water, for use in a foundry sand system, the method comprising:
(a) pre-mixing fresh particulate bond material in a pre-mix tank, with enough water to make a pumpable slurry of the bond material and water;
(b) discharging the slurry from the pre-mix tank into a discharge line and passing the slurry through a pump capable of delivering the slurry to the foundry sand system through the discharge line, and through a valve capable of closing off instructed portions of flow of the slurry;
(c) receiving a delivery command commanding adjustment of rate of delivery of the slurry to the foundry sand system; and
(d) adjusting at least one of (I) a setting on the valve and (ii) output speed of the pump, thereby to adjust rate of flow of slurry to the sand system to correspond with the commanded rate adjustment.

26. A method as in claim 25, further comprising establishing and maintaining a slurry recycle stream from the discharge line back to the pre-mix tank.

27. A method of preparing bond material for addition to a foundry sand system, comprising:
(a) pre-mixing the bond material in a pre-mix tank, with enough water to make a pumpable slurry of the bond material and water; and
(b) discharging the slurry from the pre-mix tank and pumping the discharged slurry through a pump thereby further working the slurry, and returning at least a recycle portion of the slurry to the pre-mix tank through a recycle line.

28. A method as in claim 27, further comprising initially recycling an entirety of the discharged slurry to the pre-mix tank through the recycle line thereby to work the slurry without necessarily transferring any of the slurry to the sand system.

29. A method as in claim 28, and subsequently enabling flow of a first portion of the discharged slurry to the sand system while recycling a second portion of the discharged slurry back to the pre-mix tank.

30. Apparatus for preparing bond for delivery to a foundry sand system in a foundry, said apparatus comprising:
(a) a pre-mix tank adapted and configured to receive thereinto particulate bond material and a liquid carrier therefore, to prepare a slurry of such particulate bond material and such liquid carrier, and to discharge such slurry from said pre-mix tank;
(b) a discharge line connected to said pre-mix tank at a discharge port, and adapted to receive such slurry from said pre-mix tank and to feed such slurry to a sand system in such foundry, further comprising a slurry discharge pump in said slurry discharge line; and
(c) a level sensor adapted to sense a top surface of such slurry in said pre-mix tank.

31. Apparatus as in claim 30 wherein said level sensor in said pre-mix tank comprises a radar sensor.

32. Apparatus for preparing bond for delivery to a foundry sand system in a foundry, said apparatus comprising a pre-mix system, said pre-mix system comprising:
(a) a pre-mix tank adapted and configured to receive thereinto particulate bond material and a liquid carrier therefore, to prepare a slurry of such particulate bond material and such liquid carrier, and to discharge such slurry from said pre-mix tank;
(b) a bond conveyor adapted to convey particulate bond material to a first feed port in said pre-mix tank; and
(c) a prime mover driving said bond conveyor, said prime mover comprising a variable speed drive adapted to adjust feed rate of such bond material in real time to said pre-mix tank,
whereby said prime mover can receive sequential real time drive speed commands from a controller controlling activities of said pre-mix system, and adjust feed rate of such bond material to said pre-mix tank to correspond with the speeds so commanded.

33. Apparatus as in claim 32, including a water feed line feeding into said slurry feed line upstream of said third feed port.

34. Apparatus as in claim 32, including water spray apparatus associated with a second feed port in said pre-mix tank, said water spray apparatus being designed, configured, and positioned to apply a disperse spray of water onto a stream of bond material particles traversing an open space in said pre-mix tank.

35. Apparatus as in claim 32, including a pre-mix controller which controls quantities and timing of addition of water and bond material to said pre-mix tank.

36. Apparatus as in claim 34, including a water line feeding said water spray apparatus in association with the second feed port in said pre-mix tank, further comprising a water meter in said water feed line which meters desired quantities of water to said water spray apparatus.

37. Apparatus as in claim 32, said pre-mix tank further comprising driven mixing apparatus adapted to mix such particulate bond material and such liquid carrier to thus form such slurry.

38. Apparatus as in claim 32, further comprising a level sensor adapted to sense a top surface of such slurry in said pre-mix tank.

39. Apparatus as in claim 32, said slurry discharge pump having a variable speed drive thus to vary the rate of discharging such slurry from said pre-mix tank to at least one of said recycle line and said sand system.

40. Apparatus as in claim 32 wherein said pre-mix tank is devoid of active powered mix apparatus inside said pre-mix tank.
